(19) United States
(12) Patent Application Publication
(10) Pub. No.: US 2026/0287253 A1
(43) Pub. Date: Sep. 24, 2026

(54) METHOD AND APPARATUS FOR INPUTTING THERMAL ENERGY INTO A FLUID, RELATED APPARATUS AND USES

(71) Applicant: COOLBROOK OY, Helsinki (FI)

(72) Inventors: Elina NAUHA, Helsinki (FI); Anders SIGGBERG, Helsinki (FI); Reetta KAILA, Helsinki (FI)

(21) Appl. No.: 19/473,686

(22) PCT Filed: Apr. 10, 2024
(86) PCT No.: PCT/FI2024/050167

§ 371 Date: Oct. 8, 2025

Related U.S. Application Data
(60) Provisional application No. 63/495,639, filed on Apr. 12, 2023.

(51) Int. Cl. F26B 21/35; C01G 23/08; C03B 5/235; D21H 25/04; F26B 3/06; F26B 17/10

(52) U.S. Cl. CPC F26B 21/35; C01G 23/08; C03B 5/235; D21H 25/04; F26B 3/06; F26B 17/101

(57) ABSTRACT

A method is provided for inputting thermal energy into fluidic medium in a manufacturing process by at least one rotary apparatus comprising: a casing with at least one inlet and at least one exit, a rotor comprising at least one row of rotor blades arranged over a circumference of a rotor hub mounted onto a rotor shaft, and a stator configured as an assembly of stationary vanes arranged at least upstream of the at least one row of rotor blades. In the method, an amount of thermal energy is imparted to a stream of fluidic medium directed along a flow path formed inside the casing between the inlet and the exit by virtue of a series of energy transformations occurring when said stream of fluidic medium passes through the stationary vanes and the at least one row of rotor blades, respectively. The method further comprises: integration of said at least one rotary apparatus into a production facility configured to carry out material production processes, such as producing titanium oxide, mineral wool, gypsum, wood pulp and paper, cathodes and anodes, or flash-dried chemicals, at temperatures essentially equal to or exceeding 500 degrees Celsius (° C.), and conducting an amount of input energy into the at least one rotary apparatus integrated into the heat-consuming process facility, the input energy comprises electrical energy. A rotary apparatus and related uses are further provided.

### FIELD OF THE INVENTION

The present invention generally relates to systems and methods for inputting thermal energy (heat) into fluids. In particular, the invention relates to tools and processes for optimizing energy efficiency and reducing greenhouse gas and particle emissions in heat-consuming industrial processes, such as the production of titanium oxide, stone- and mineral-wool, gypsum, wood pulp and paper, and cathode and anode material, and the flash drying of chemicals, which may be carried out at high and extremely high temperatures and/or include step(s) that are performed at high and extremely high temperatures.

### BACKGROUND

Industry and governments have been combating to find technologies to achieve significant reductions in greenhouse gas (GHG) emission. Heavy industrial processes, such as the production of metal oxide pigments, stone- and mineral-wool, gypsum, wood pulp and paper, and battery materials, and the flash drying of chemicals (collectively referred to herein as “industrial processes”), have a key role to reach low emission targets set by companies, governments and international organizations. Electrification of these processes has been seen as a solution to reduce emissions. One of the obstacles for electrification was achieving high temperatures needed in these industrial processes. By way of example, the production of titanium (di) oxide may be performed according to two different processing routes: a sulfate-based process with a high-temperature (up to 1100° C.) calcination step or a chloride-based process with both a high-temperature (up to 1200° C.) chlorination step and a high-temperature (up to 1400° C.) oxidation step. Melting raw minerals for spinning and binding into mineral-wool is performed in a furnace at temperatures of about 1300° C. to 1500° C. Calcination of calcium carbonate in a gypsum manufacturing process proceeds, in turn, at a temperature of up to 1200° C. High-temperature calcination of calcium carbonate is also a part of a Kraft process for manufacturing wood pulp. Similar temperature ranges (up to 1300-1500° C.) are reached in calcination, sintering, and carbonization furnaces in battery manufacturing. The processes of drying substances may also reach the temperature of about 1000° C. and beyond, depending on materials to be dried and the process requirements. These high-temperature processes set strict requirements for energy sources and utilized technologies. In particular, while electricity is already used for some high-temperature processes (such as in electric arc furnaces, for example), in most cases, neither the technologies nor the economics are yet in place for its widespread adoption.

A number of rotary solutions have been proposed for heating purposes. Thus, U.S. Pat. No. 11,098,725 B2 (Sanger et al) discloses a hydrodynamic heater pump device operable to selectively generate a stream of heated fluid and/or pressurized fluid. A mentioned hydrodynamic heater pump is designed to be incorporated in an automotive vehicle cooling system to provide heat for warming a passenger compartment of the vehicle and to provide other capabilities, such as window deicing and engine cooling. The disclosed device may also provide a stream of pressurized fluid for cooling an engine. Disclosed technology is based on friction; and, since the fluid to be heated is liquid, the presented design is not suitable for conditions involving extreme turbulence of gas aerodynamics.

U.S. Pat. No. 7,614,367 B1 (Frick) discloses a system and method for flamelessly heating, concentrating or evaporating a fluid by converting rotary kinetic energy into heat. Configured for fluid heating, the system may comprise a rotary kinetic energy generator, a rotary heating device, and a primary heat exchanger, all in closed-loop fluid communication. The rotary heating device may be a water brake dynamometer. The document discloses the use of the system for heating water in offshore drilling or production platforms. However, the presented system is not suitable for heating gaseous media, neither is it feasible for use with high and extremely high temperatures (due to liquid stability, vapor pressure, etc.).

Additionally, some rotary turbomachine-type devices are known to implement the processes of hydrocarbon (steam) cracking and aim at maximizing the yields of the target products, such as ethylene and propylene.

In this regard, an update in the field of technology related to design and manufacturing of efficient heating systems, in particular those suitable for high and extremely high temperature related applications, is still desired, in view of addressing challenges associated with raising temperatures of fluidic substances in efficient and environmentally friendly manner.

### SUMMARY OF THE INVENTION

An objective of the present invention is to solve or to at least mitigate at least some of the problems arising from the limitations and disadvantages of the related art. One or more objectives are achieved by various embodiments of the methods for generation of a heated fluidic medium described herein, the rotary apparatuses and related uses as defined herein.

In an aspect, a method for titanium oxide production is provided, the method comprising generation of a heated fluidic medium by at least one rotary apparatus integrated into a titanium oxide production facility, the heated fluidic medium being configured to supply heat to a calcination process for reacting titanium hydroxide to form titanium oxide.

In another aspect, a method for titanium oxide production comprises generation of a heated fluidic medium by at least one rotary apparatus integrated into a titanium oxide production facility, the heated fluidic medium being configured to supply heat to a chlorination process for reacting ilmenite (FeTiO₃) to form titanium chloride, and/or an oxidation process for reacting titanium chloride to form titanium oxide.

In another aspect, a method for mineral or stone wool production is provided, the method comprising generation of a heated fluidic medium by at least one rotary apparatus integrated into a mineral wool production facility, the heated fluidic medium being configured to supply heat to a melting process for melting raw materials such as inorganic volcanic rock or slag form a melt that is spun into fibers and formed into wool.

In another aspect, a method for gypsum production is provided, the method comprising generation of a heated fluidic medium by at least one rotary apparatus integrated into a gypsum production facility, the heated fluidic medium being configured to supply heat to a calciner for dehydrating gypsum.

In another aspect, a method for wood pulp production, such as in wood pulp and paper production, is provided, the method comprising generation of a heated fluidic medium by at least one rotary apparatus integrated into a wood pulp production facility, the heated fluidic medium being configured to supply heat to a Kraft process, which includes a lime kiln (1100° C.) for reacting calcium carbonate (CaCO₃) to form carbon dioxide (CO₂) and calcium oxide (CaO). In another aspect, a method for wood pulp production comprises generation of a heated fluidic medium by at least one rotary apparatus integrated into a wood pulp production facility, the heated fluidic medium being configured to supply heat to a Yankee Hood for drying tissue paper.

In another aspect, a method for cathode/anode material production is provided, the method comprising generation of a heated fluidic medium by at least one rotary apparatus integrated into a cathode and/or anode production facility, the heated fluidic medium being configured to supply heat to a kiln and burner used in the production of cobalt, nickel, manganese, and/or graphite.

In another aspect, a method for flash drying of one or more chemicals is provided, the method comprising generation of a heated fluidic medium by at least one rotary apparatus integrated into a chemical production facility, the heated fluidic medium being configured to supply heat to a flash dryer.

According to an embodiment, the methods described above, which comprises generation of a heated fluidic medium by at least one rotary apparatus integrated into the industrial production facility, improve energy efficiency or reduce greenhouse gas and particle emissions, or both.

In embodiments, the methods described above comprise generation of a heated fluidic medium by virtue of at least one rotary apparatus integrated into an industrial process production facility, the at least one rotary apparatus comprising: a casing with at least one inlet and at least one exit (outlet), a rotor comprising at least one row of rotor blades arranged over a circumference of a rotor hub mounted onto a rotor shaft, and a plurality of stationary blades or vanes arranged into an assembly adjacent to the at least one row of rotor blades, such as at least upstream of the at least one row of rotor blades, wherein an amount of thermal energy is imparted to a stream of fluidic medium directed along a flow path formed inside the casing between the inlet and the exit (outlet) by virtue of a series of energy transformations occurring when said stream of fluidic medium passes through the stationary vanes and the at least one row of rotor blades, respectively, whereby a stream of heated fluidic medium is generated; the method further comprises: conducting an amount of input energy into the at least one rotary apparatus integrated into the heat-consuming process facility, the input energy comprises electrical energy, supplying the stream of heated fluidic medium generated by the at least one rotary apparatus into the industrial production facility, and operating said at least one rotary apparatus and said industrial production facility to carry out the methods described above at temperatures essentially equal to or exceeding about 500 degrees Celsius (° C.).

In an embodiment, the methods comprise inputting thermal energy into an industrial process or processes, and the methods include generation of a heated fluidic medium by at least one rotary apparatus integrated into an industrial production facility, the at least one rotary apparatus comprising a casing with at least one inlet and at least one exit (outlet), a rotor comprising at least one row of rotor blades arranged over a circumference of a rotor hub mounted onto a rotor shaft, and a plurality of stationary blades or vanes arranged into an assembly adjacent to the at least one row of rotor blades, such as at least upstream of the at least one row of rotor blades, the method further comprises: integrating the at least one rotary apparatus into the industrial production facility configured to carry out high or extremely high temperature process or processes related to production of materials essentially equal to or exceeding about 500 degrees Celsius (° C.); conducting an amount of input energy into the at least one rotary apparatus integrated into the industrial production facility, the input energy comprising electrical energy, and operating the at least one rotary apparatus integrated into the industrial production facility such, that an amount of thermal energy is imparted to a stream of fluidic medium directed along a flow path formed inside the casing between the inlet and the exit (outlet) by virtue of a series of energy transformations occurring when said stream of fluidic medium passes through the stationary vanes and the at least one row of rotor blades, respectively, whereby a stream of heated fluidic medium is generated.

In embodiments, the method comprises generation of the fluidic medium heated to the temperature essentially equal to or exceeding about 500 degrees Celsius (° C.), or to the temperature essentially equal to or exceeding about 1200° C., or to the temperature essentially equal to or exceeding about 1700° C.

In embodiments, the method comprises adjusting velocity and/or pressure of the stream of fluidic medium propagating through the rotary apparatus, to produce conditions, at which the stream of the heated fluidic medium is generated.

In embodiments, in said method, the heated fluidic medium is generated by at least one rotary apparatus comprising two or more rows of rotor blades sequentially arranged along the rotor shaft.

In an embodiment, in said method, the heated fluidic medium is generated by at least one rotary apparatus further comprising a diffuser area arranged downstream of the at least one row of rotor blades, the method furthers comprises operating the at least one rotary apparatus integrated into the industrial production facility such, that an amount of thermal energy is imparted to a stream of fluidic medium directed along a flow path formed inside the casing between the inlet and the exit by virtue of a series of energy transformations occurring when said stream of fluidic medium successively passes through the stationary guide vanes, the at least one row of rotor blades and the diffuser area, respectively, whereby a stream of heated fluidic medium is generated. The diffuser area may be configured with or without stationary vanes.

In embodiments, in said method, the amount of thermal energy added to the stream of fluidic medium propagating through the rotary apparatus is controlled by adjusting the amount of input energy conducted into the at least one rotary apparatus integrated into the industrial production facility.

In embodiments, the method further comprises arranging an additional heating apparatus downstream of the at least one rotary apparatus and introducing a reactive compound or a mixture of reactive compounds to the stream of fluidic medium propagating through the rotary apparatus and/or through said additional heating apparatus, whereupon the amount of thermal energy is added to said stream of fluidic medium through exothermic reaction(s). In embodiment, the reactive compound or a mixture of reactive compounds is introduced to the stream of fluidic medium preheated to a predetermined temperature. In embodiment, the reactive compound or a mixture of reactive compounds is introduced to the stream of fluidic medium preheated to a temperature essentially equal to or exceeding about 1700° C. In embodiment, preheating of the stream of fluidic medium to the predetermined temperature is implemented in the rotary apparatus.

In an embodiment, the method comprises generation of the heated fluidic medium by at least two rotary apparatuses integrated into the industrial production facility, wherein the at least two rotary apparatuses are connected in parallel or in series. In embodiments, the method comprises generation of the heated fluidic medium by at least two sequentially connected rotary apparatuses, wherein the stream of fluidic medium is preheated to a predetermined temperature in at least a first rotary apparatus in a sequence, and wherein said stream of fluidic medium is further heated in at least a second rotary apparatus in the sequence by inputting an additional amount of thermal energy into the stream of preheated fluidic medium propagating through said second rotary apparatus. In an embodiment, in said method, in at least the first rotary apparatus in the sequence, the stream of fluidic medium is preheated to a temperature essentially equal to or exceeding about 1700° C. In an embodiment, in said method, the additional amount of thermal energy is added to the stream of fluidic medium propagating through said at least second rotary apparatus in the sequence by virtue of introducing the reactive compound or a mixture of reactive compounds into said stream. In an embodiment, the method comprises introducing the reactive compound or a mixture of reactive compounds into a process or processes related to the production of titanium oxide (pigment), mineral-wool, gypsum, wood pulp, or tissue paper. Such process or processes can for example be implemented in a furnace configured for production of the same.

In an embodiment, in said method, the heated fluidic medium generated by the at least one rotary apparatus is selected from the group consisting of: a feed gas, a recycle gas, a make-up gas, and a process fluid. In an embodiment, in said method, the fluidic medium that enters the rotary apparatus is an essentially gaseous medium.

In an embodiment, the method comprises generation of the heated fluidic medium in the rotary apparatus. In embodiments, in said method, the fluidic medium to be heated in the rotary apparatus comprises any one of: air, steam (H₂O), nitrogen (N₂), hydrogen (H₂), carbon dioxide (CO₂), carbon monoxide (CO), methane (CH₄), or any combination thereof. Any other gas can be utilized where appropriate. In an embodiment, in said method, the fluidic medium to be heated in the rotary apparatus is a recycle gas recycled from off-gases, such as exhaust gases, generated from (i) calcinating titanium hydroxide to produce titanium oxide, (ii) chlorinating ilmenite to form titanium chloride, (iii) oxidizing titanium chloride to form titanium oxide, (iv) melting raw minerals to produce a melt configured to be spun into fibers for forming mineral-wool, (v) dehydrating crushed gypsum ore, (vi) reacting calcium carbonate to form carbon dioxide and calcium oxide in a Kraft process, (vii) dehydrating tissue paper in a Yankee Hood, (viii) calcinating and/or oxidizing raw materials for cathode and/or anode production, or (ix) drying chemicals in a flash drying process.

In embodiments, the method further comprises generation of the heated fluidic medium, such as gas, vapor, liquid, and mixtures thereof, and/or heated solid materials, outside the rotary apparatus through a process of heat transfer between the heated fluidic medium generated in the rotary apparatus and any one of the above-mentioned substances bypassing the rotary apparatus.

In embodiments, the method further comprises supplying the heated fluidic medium generated by the at least one rotary apparatus or in the at least one rotary apparatus into at least one heat-consuming unit within the industrial production facility, the heat-consuming unit being provided as any one of: (i) a calcinator (also referred to as a calciner) configured for calcinating titanium hydroxide into titanium oxide, (ii) a reactor configured to chlorinate ilmenite to form titanium chloride, (iii) a reactor configured to oxidize titanium chloride to form titanium oxide, (iv) a furnace configured to melt raw minerals for spinning and binding into mineral-wool, (v) a calciner configured for calcination and dehydration of crushed gypsum ore, (vi) a lime kiln for reacting calcium carbonate to form carbon dioxide and calcium oxide as part of a Kraft process, (vii) a Yankee Hood for drying tissue paper, (viii) a calcinator or other reactor for forming cathode and/or anode materials, or (ix) a dryer for flash drying of chemicals. In embodiments, the heat-consuming unit comprises or consists of a conversion reactor configured to perform thermal or thermochemical conversion (with or without decomposition) of feedstocks to desired products.

In embodiments, the method further comprises increasing pressure in the stream of fluidic medium propagating through the rotary apparatus.

In embodiment, in said method, the amount of electrical energy conducted as the input energy into the at least one rotary apparatus integrated in the industrial production facility is within a range of about 5 percent to 100 percent.

In embodiment, in said method, the amount of electrical energy conducted as the input energy into the at least one rotary apparatus integrated in the industrial production facility is obtainable from a source of renewable energy or a combination of different sources of energy, optionally, renewable energy.

In embodiment, in said method, the at least one rotary apparatus is utilized to balance variations, such as oversupply and shortage, in the amount of electrical energy (obtained through supply and/or production, for example), optionally renewable electrical energy, by virtue of being integrated, into the industrial production facility, together with an at least one non-electrical energy operable heater device.

In another aspect, a titanium oxide production facility is provided, said titanium oxide production facility comprising at least one rotary apparatus configured to generate a heated fluidic medium and at least one heat-consuming unit configured to carry out a process of processes related to titanium oxide production, in accordance with the present disclosure.

In another aspect, a mineral-wool production facility is provided, said mineral-wool production facility comprising at least one rotary apparatus configured to generate a heated fluidic medium and at least one heat-consuming unit configured to carry out a process of processes related to mineral-wool production, in accordance with the present disclosure.

In another aspect, a gypsum production facility is provided, said gypsum production facility comprising at least one rotary apparatus configured to generate a heated fluidic medium and at least one heat-consuming unit configured to carry out a process of processes related to gypsum, crushed gypsum, plaster, or stucco production, in accordance with the present disclosure.

In another aspect, a wood pulp and paper production facility is provided, said wood pulp and paper production facility comprising at least one rotary apparatus configured to generate a heated fluidic medium and at least one heat-consuming unit configured to carry out a process of processes related to the Kraft process and tissue paper production, in accordance with the present disclosure.

In another aspect, a cathode or anode production facility is provided, said cathode or anode production facility comprising at least one rotary apparatus configured to generate a heated fluidic medium and at least one heat-consuming unit configured to carry out a process of processes related to cathode and/or anode production for use in batteries, in accordance with the present disclosure.

In another aspect, a chemical production facility is provided, said chemical production facility comprising at least one rotary apparatus configured to generate a heated fluidic medium and at least one heat-consuming unit configured to carry out a process of processes related to flash drying of chemicals, in accordance with the present disclosure.

In an aspect, a method for inputting thermal energy into a process or processes related to producing a material in a production facility is provided, the method comprising generation of a heated fluidic medium by at least one rotary apparatus integrated into the production facility, the at least one rotary apparatus comprising: a rotor with a plurality of rotor blades arranged into at least one row around a rotor hub mounted onto a rotor shaft, a plurality of stationary blades or vanes arranged into an assembly adjacent to the at least one row of rotor blades, and a casing with a duct formed between at least one inlet and at least one outlet, the duct configured to encompass rotating and stationary blades such that bladeless portion(s) of the duct is/are arranged essentially subsequently to bladed portions thereof, the method further comprises:
integrating the at least one rotary apparatus into the production facility configured to carry out process or processes related to production of the material at temperatures essentially equal to or exceeding about 500 degrees Celsius (° C.),
conducting an amount of input energy into the at least one rotary apparatus integrated into the production facility, the input energy comprising electrical energy, and operating the at least one rotary apparatus integrated into the production facility such, that thermal energy is imparted to a stream of fluidic medium flowing in the duct between the inlet and the outlet by virtue of a series of energy transformations occurring when said stream of fluidic medium successively passes through bladed and bladeless portions of the duct,
whereby a stream of heated fluidic medium is generated, and wherein the material produced includes one of (i) titanium oxide, (ii) mineral-wool, (iii) gypsum, (iv) wood pulp and paper, (v) cathodes/anodes for batteries, or (vi) flash-dried chemicals.

In embodiments, the process related to producing the material in the production facility is any one of: (i) calcinating titanium hydroxide to produce titanium oxide, (ii) chlorinating ilmenite to form titanium chloride, (iii) oxidizing titanium chloride to form titanium oxide, (iv) melting raw minerals to produce a melt configured to be spun into fibers for forming mineral-wool, (v) dehydrating crushed gypsum ore, (vi) reacting calcium carbonate to form carbon dioxide and calcium oxide in a Kraft process, (vii) dehydrating tissue paper in a Yankee Hood, (viii) calcinating and/or oxidizing raw materials for cathode and/or anode production, or (ix) drying chemicals in a flash drying process.

In one or more aspects, various production facilities are contemplated. Solely in the interest of brevity, where aspects of the rotary device are substantially similar, the production facility aspects described above are referred to collectively herein as “industrial production facilities”.

In an embodiment, the industrial production facility comprises at least one rotary apparatus configured to generate a heated fluidic medium and at least one heat-consuming unit configured to carry out a process of processes related to industrial production, the at least one rotary apparatus comprising: a casing with at least one inlet and at least one exit (outlet), a rotor comprising at least one row of rotor blades arranged over a circumference of a rotor hub mounted onto a rotor shaft, and a plurality of stationary blades or vanes arranged into an assembly adjacent to the at least one row of rotor blades, such as at least upstream of the at least one row of rotor blades, wherein the at least one rotary apparatus is configured to operate such that an amount of thermal energy is imparted to a stream of fluidic medium directed along a flow path formed inside the casing between the inlet and the exit (outlet) by virtue of a series of energy transformations occurring when said stream of fluidic medium successively passes through the stationary vanes and the at least one row of rotor blades respectively, whereby a stream of heated fluidic medium is generated, and wherein said at least one rotary apparatus is configured to receive an amount of input energy, the input energy comprising electrical energy, and to generate a heated fluidic medium for inputting thermal energy into at least one heat-consuming unit configured to carry out a process or processes related to industrial production at temperatures essentially equal to or exceeding about 500 degrees Celsius (° C.).

In an embodiment, the at least one rotary apparatus provided within said industrial production facility is further configured to increase pressure in the fluidic stream propagating therethrough.

In some configurations, the at least one rotary apparatus provided within said industrial production facility is configured to implement a fluidic flow, between the inlet and the exit, along a flow path established in accordance with any one of: an essentially helical trajectory formed within an essentially toroidal-shaped casing; an essentially helical trajectory formed within an essentially tubular casing, an essentially radial trajectory, along a flow path essentially parallel to a rotor shaft enclosed in the essentially tubular casing, and along the flow path established by virtue of the stream of fluidic medium in the form of two spirals rolled up into vortex rings of right and left directions.

In a further aspect, an assembly is provided and comprises at least two rotary apparatuses according to some previous aspect, said rotary apparatuses being connected in parallel or in series.

In a further aspect, an arrangement is provided and comprises at least one rotary apparatus according to some previous aspect, said at least one rotary apparatus being connected to at least one furnace.

As used herein, a “furnace” refers to an apparatus in which heat is produced or added as part of a combustion process. The furnace may be a blast furnace, a cupola furnace, a pot and tank furnace, a shaft furnace, a regenerative furnace, or another furnace depending on the needs of the specific application. The decision to recite “furnace” to the exclusion of any specific type of furnace or another apparatus for combustion is in the interest of brevity only and is not intended to limit the scope of the invention.

In a further aspect, an industrial production facility is provided and is configured to implement a industrial production processes through a method according to some previously defined aspects and embodiments; and it comprises at least one rotary apparatus according to some previous aspect.

The utility of the present invention arises from a variety of reasons depending on each particular embodiment thereof.

Overall, embodiments offer an electrified rotary fluid heater to provide high temperature fluids, such as gases, to be used in the production of metal oxides (pigments), such as titanium oxide, mineral-wool, gypsum, wood pulp and paper, cathodes and anodes, and flash-dried chemicals instead of fuel-fired heaters, for example. The presented method enables inputting thermal energy into furnaces used in the production of these materials operating at high- and extremely high temperatures, such as temperatures generally exceeding 500° C. The invention offers apparatuses and methods for heating the fluidic substances to the temperatures within a range of about 500° C. to about 2000° C., i.e. the temperatures used in industrial production.

Production of the materials described above typically employ utilities with high demand for thermal energy and hence, for heat consumption, such as fired heaters, for example. Said heat-consuming utilities are used to heat fluids to temperatures needed for the production process. The invention presented herewith enables replacing conventional heat-consuming utilities, such as fuel-fired heaters, by a rotary apparatus or apparatuses. In the method, the advantages achieved by replacing fuel-fired heaters with at least one rotary apparatus include at least:
Support for electrified heating;
Elimination or at least significant reduction of greenhouse gas (such as NO, CO₂, CO, NO_{X}), other harmful components (such as for example HCl, H₂S, SO₂, and heavy metals) originating from fuels, particle emissions and soot emissions;
Reduced volume of a heater: the volume of the rotary apparatus is at least one order of magnitude smaller as compared to the volume of conventional process heaters or heat exchangers;
Decreased investment costs;
Improved safety in case of using flammable, hazardous fluids/gases;
Feasibility in handling large volumes of gases;
Absence of pressure drop;
Possibility of using the rotary (heater) apparatus also for compression of gases (a blower function);
Independency on temperature difference in direct heating of gases. Temperature rise in the rotary apparatus can be in range of about 10 to 1700° C. or more;
Possibility for using the rotary apparatus in indirect heating of fluids optionally by optimizing temperature difference in heat exchanger(s);
Possibility for at least partial recycling of hot process gases, thus improving and making simpler the heat recovery and improving energy efficiency;
Possibility for further raising the temperature of gases to be heated by adding reactive chemicals which further increase the gas temperature up to e.g. 2000° C. or higher by exothermic reactions.

In embodiments, the rotary apparatus can be used to replace conventional fired heaters or process furnaces for direct or indirect heating of materials in the production processes described above. Traditionally such heat has been mainly produced through burning of fossil fuels leading to significant CO₂ emissions. Replacing fossil fuels with wood or other bio-based materials has significant resource limitations and other serious environmental implications, such as sustainable land use. With increased cost-efficiency of renewable electricity, namely, with rapid development of wind and solar power, it is possible to replace fossil fuel firing with rotary apparatus(-es) powered with renewable electricity, thus leading to significant greenhouse gas emission reductions. The rotary apparatus allows electrified heating of fluids to temperatures up to 1700° C. and higher. Such temperatures are difficult or impossible to reach with current electrical heating applications.

The rotary apparatus can be used for direct heating of process gases, inert gases, air or any other gases or for indirect heating of process fluids (liquid, vapor, gas, vapor/liquid mixtures etc.). Heated fluid generated in said rotary apparatus can be used for heating of any one of: gases, vapor, liquid, and solid materials. In particular, the rotary apparatus can be used for direct heating of gas recycled from the exhaust gases generated in heat-consuming processes utilized in the production of materials described herein. The rotary apparatus can at least partly replace, or it can be combined with (e.g. as pre-heater) multiple types of furnaces, heaters, kilns, gasifiers, and reactors that are traditionally fired or heated with solid, liquid or gaseous fossil fuels or in some cases bio-based fuels. Such appliances include but are not limited to: furnaces, ovens, kilns, heaters, burners, incinerators, boilers, dryers, conveyor devices, reactors, and their combinations. Some particular examples include, but are not limited to: blast furnaces, cupola furnaces, pot and tank furnaces, shaft furnaces, regenerative furnaces, rotary kilns, steam boilers, catalytic reactors and fluidized bed reactors. Heated gases can be flammable, reactive, or inert and they can be recycled back to the rotary apparatus. In addition to heating, the rotary apparatus may act as combined blower and heater allowing to increase pressure and to recycle gases.

Heated fluids, such as gases, can be used in a variety of applications. Moreover, a heated object can be a solid material, liquid or gas, which gas further takes part in a number of reactions or is used as a heating media. Hence, hot gases can be used for heating solid materials, such as those used in various industrial facilities, including production facilities for manufacturing of titanium oxide, mineral-wool, gypsum, wood pulp and paper, cathode/anode materials, and/or chemical production factories. Furthermore, the rotary apparatus(es) described herewith can be applied, within the production process(es)/facilities, for provision of heat and fluidization in fluidized bed applications.

The invention enables the reduction of greenhouse gas (CO, CO₂, NOₓ) and particle emissions when replacing fired heaters by the rotary apparatus(-es). By using the rotary apparatus(-es), it is further possible to have closed or semi-closed heating loops for heat-consuming processes, and to improve energy efficiency of these processes by reducing heat losses through flue gas. In conventional heaters, flue gases can be recycled only partly.

Additionally, the present solution enables improved optimization of temperature difference(s) in the heat exchangers used in indirect heating.

The invention further provides for flexibly using electrical energy, such as electrical energy obtainable from renewable sources. Production of renewable energy typically varies on daily basis and even on hourly basis. The invention allows for balancing renewable electricity production by integration of the rotary apparatus(-es) disclosed herewith with conventional fuel-operated (fuel-fired) heaters to provide heat to industrial production processes, for example.

The invention further enables a reduction in the on-site investment costs as compared to traditional fossil fuel-fired furnaces.

The expression “a number of” refers hereby to any positive integer starting from one (1), e.g. to one, two, or three. The expression “a plurality of” refers hereby to any positive integer starting from two (2), e.g. to two, three, or four. The terms “first” and “second”, are used hereby to merely distinguish an element from another element without indicating any particular order or importance, unless explicitly stated otherwise.

The term “gasified” is utilized hereby to indicate matter being converted into a gaseous form by any possible means.

Different embodiments of the present invention will become apparent by consideration of the detailed description and accompanying drawings.

### BRIEF DESCRIPTION OF THE DRAWINGS

FIG. 1 is a block diagram representing, at 1000, a layout for a high temperature heat-consuming process facility configured to implement a method according to the embodiments.

FIGS. 2A-2F are exemplary layouts of arranging rotary apparatus(es) 100 within a production facility, according to the embodiments.

FIGS. 3-10 are schematic representations of facilities and method(s) according to the embodiments.

### DETAILED DESCRIPTION OF THE EMBODIMENTS

Detailed embodiments of the present invention are disclosed herein with the reference to accompanying drawings.

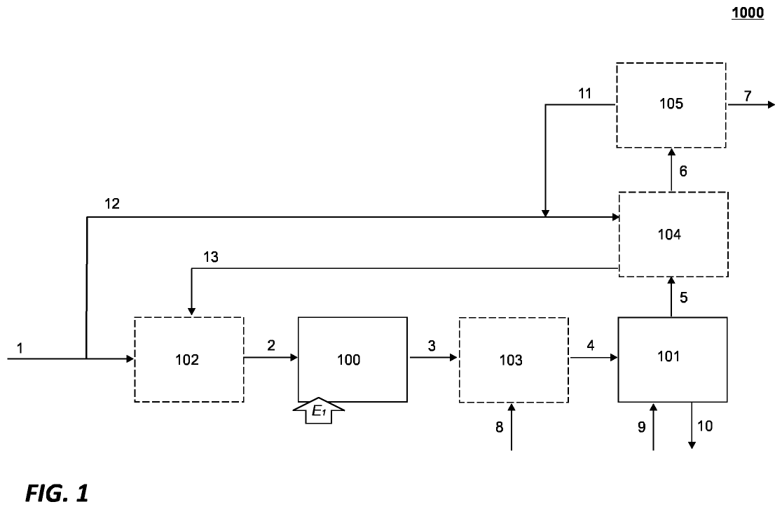

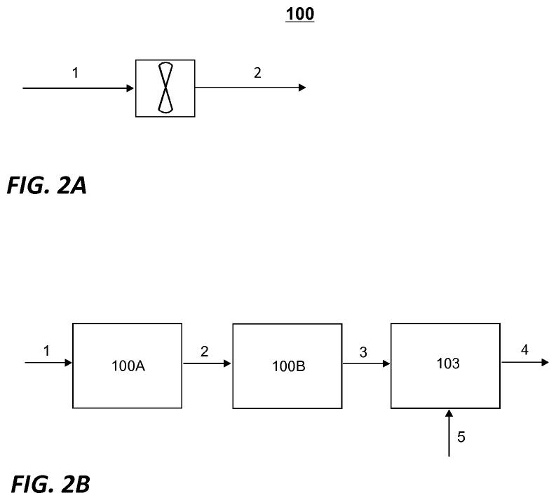

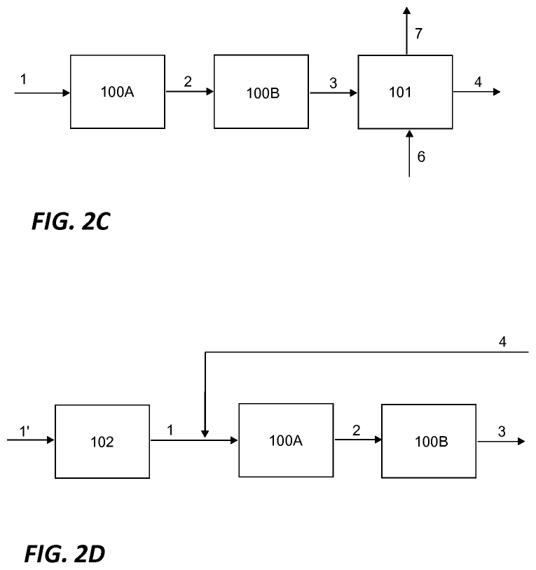

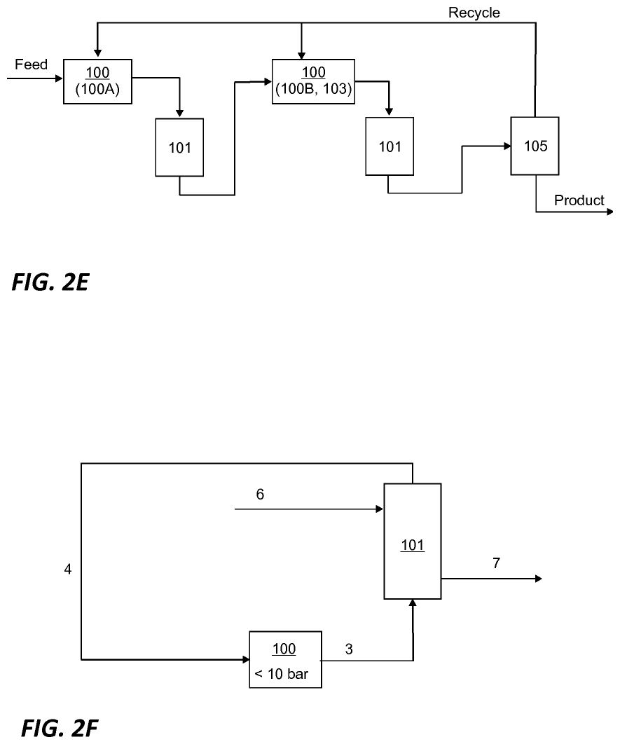

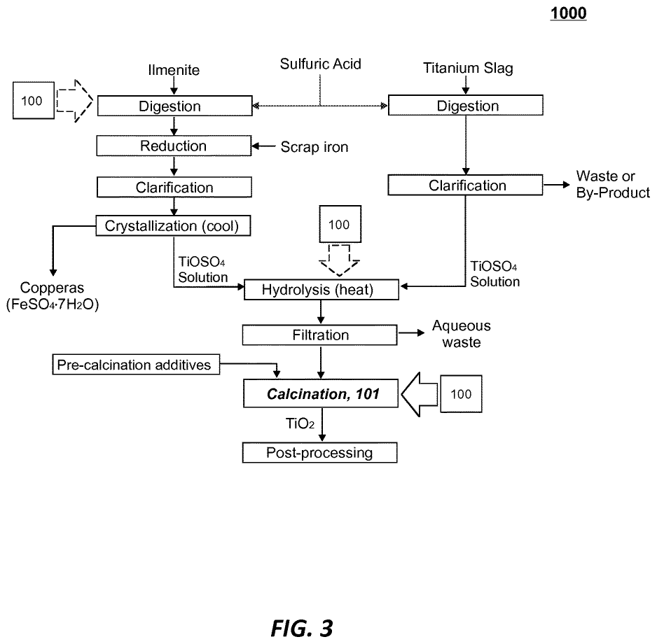

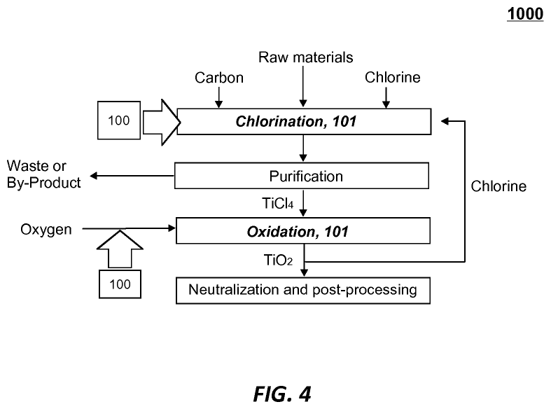

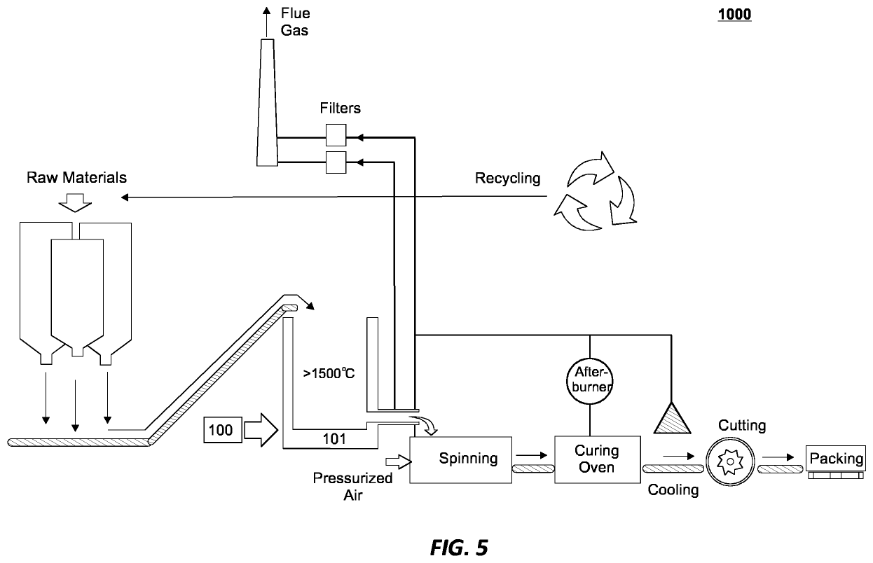

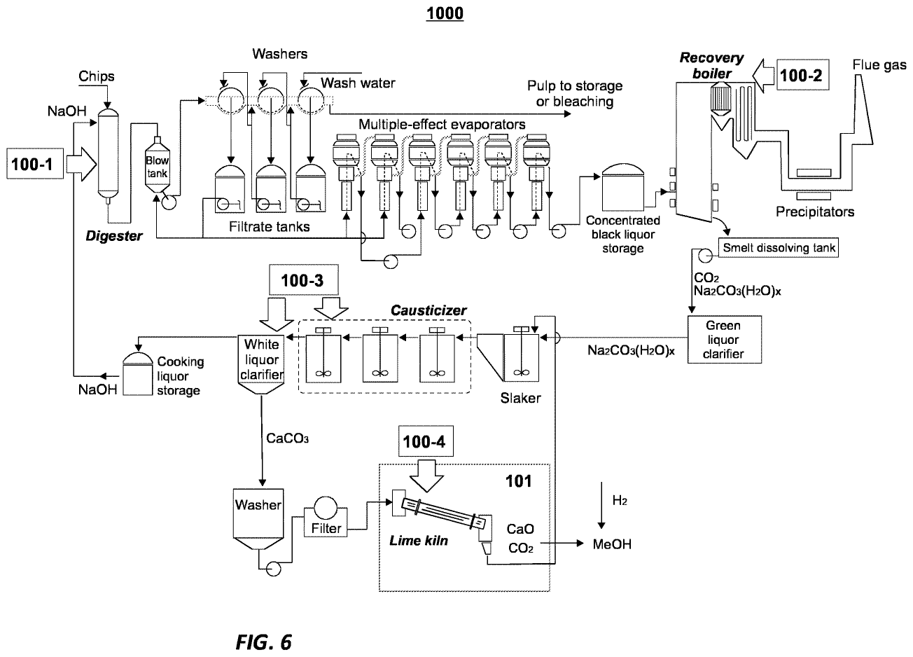

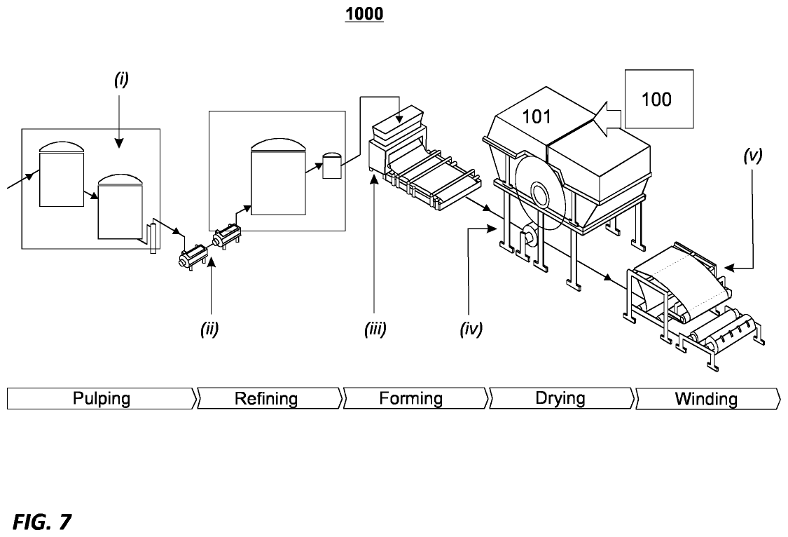

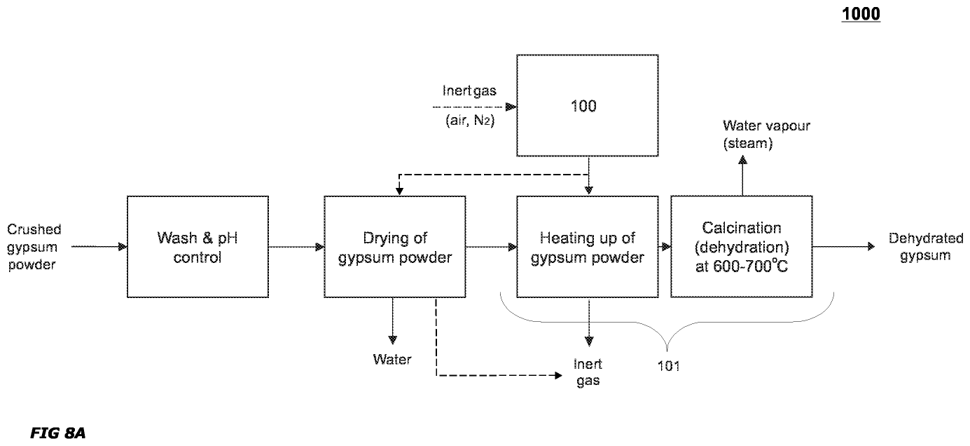

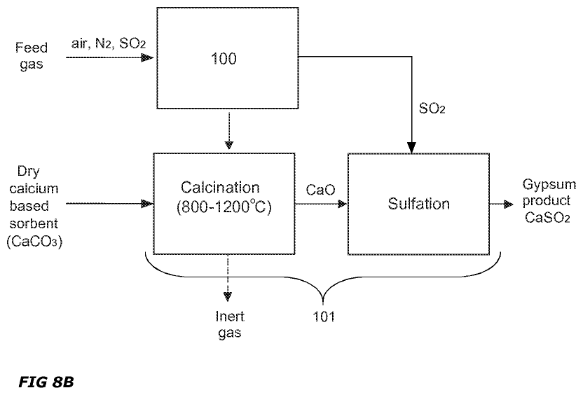

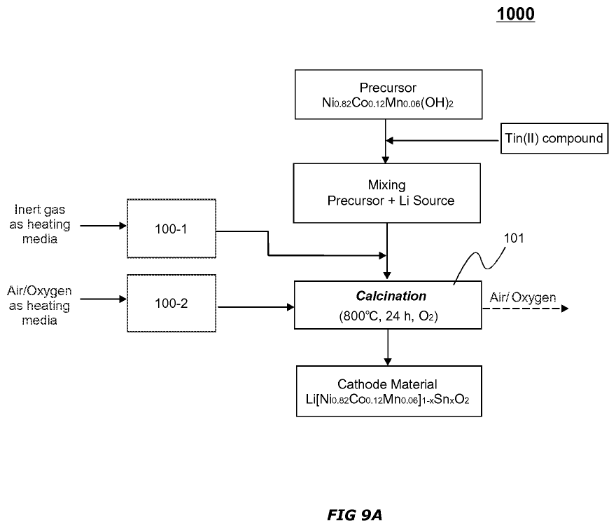

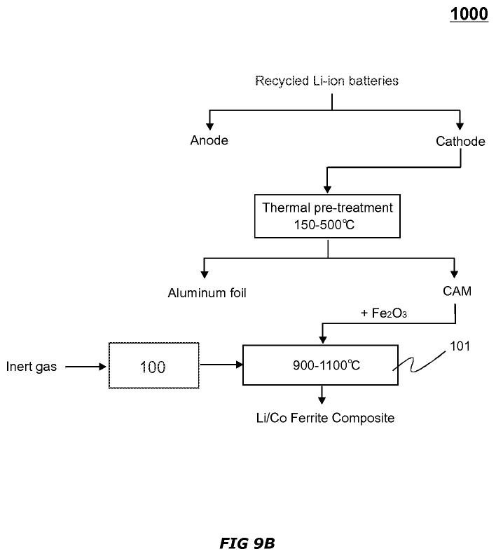

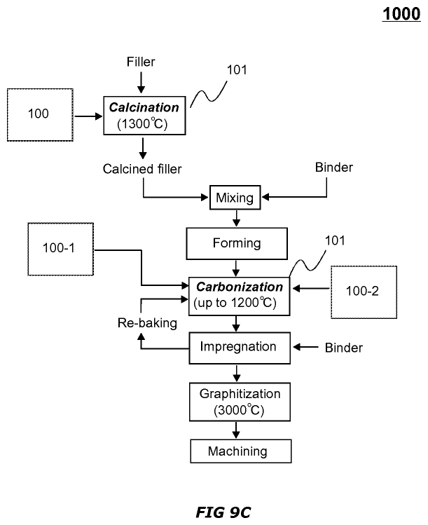

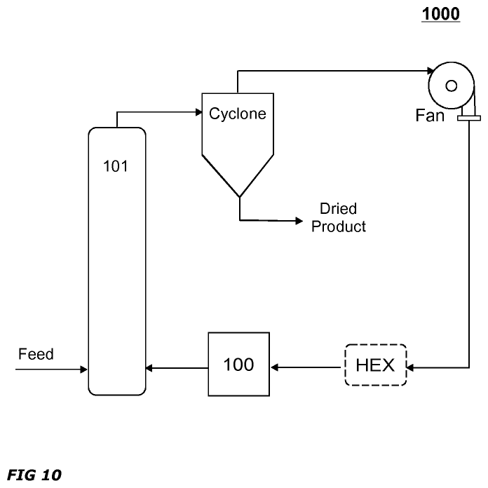

FIG. 1 is a block diagram representing, at 1000, a layout for a high temperature heat-consuming process facility configured to implement a method according to the embodiments. FIGS. 2A-2F and FIGS. 3-10 describe apparatuses and methods according to the embodiments. In particular, FIGS. 3-10 illustrate a variety of heat-consuming industrial processes and the ways of integration of at least one rotary apparatus thereinto. FIG. 3 schematically depicts a sulfate-based titanium oxide production process. FIG. 4 schematically depicts a chlorine-based titanium oxide production process. FIG. 5 schematically depicts a mineral-wool production process. FIG. 6 schematically depicts a Kraft process for wood pulp production. FIG. 7 schematically depicts a tissue paper production process. FIG. 8A schematically depicts a gypsum production process. FIG. 8B schematically depicts the gypsum production process using a dry sorbent injection (DSI) technology. FIGS. 9A and 9B schematically depict processes for cathode material production, and FIG. 9C schematically depicts a process for anode material production. FIG. 10 schematically depicts a flash drying process for drying chemicals. The figures and related examples serve illustrative purposes and are not intended to limit applicability of the inventive concept to the layouts expressly presented in this disclosure. Block diagram sections shown by dotted lines are optional.

For FIG. 1, the following designations are used for the members. Streams: 1. Feed; 2. Preheated feed mixture; 3. Feed heated by a rotary apparatus (100); 4. Feed after raising-/enhancing its temperature in an (additional) heater section or a heater unit, also referred to as a booster section (unit), through (exothermic) chemical reactions, for example; 5. Fluidic medium exiting a heat-consuming unit/process and directed to heat recovery; 6. Fluidic medium sent to purification; 7. Product or waste gas; 8. Reactive compound or a mixture of compounds, e.g. a reactive chemical or chemicals, or a support fuel, to increase temperature in the booster section; 9. Process stream (solid, liquid, gas, vapor or a mixture thereof) to be heated by hot fluidic medium in a heat-consuming process section; 10. Heated process stream (solid, liquid, gas, vapor or a mixture thereof) sent for further processing or to storage; 11. Recycle stream from purification; 12. Feed stream to heat recovery; 13. Hot fluidic stream from heat recovery. Sections (units): 100. Rotary heater unit (rotary apparatus(es)); 101. Heat-consuming unit/process; 102. Preheater unit; 103. Booster heater section (unit); 104. Heat recovery unit; 105. Purification unit.

Heat-consuming process facility 1000 is a facility configured to carry out a heat-consuming industrial process or processes 101 at temperatures essentially equal to—or exceeding 500 degrees Celsius (° C.). In embodiments, the facility is configured to carry out the heat-consuming industrial process(es) at temperatures essentially equal to—or exceeding 1200° C. In embodiments, the facility is configured to carry out the heat-consuming industrial process(es) at temperatures essentially equal to—or exceeding 1700° C. In some embodiments, the facility can be configured to carry out industrial process(es) at temperatures that exceed 1700° C., such as at 2000° C. or higher, such as within a range of about 1700° C. to about 2500° C. The facility can be configured to carry out industrial process(es) at about 1700° C., at about 1800° C., at about 1900° C., at about 2000° C., at about 2100° C., at about 2200° C., at about 2300° C., at about 2400° C., at about 2500° C., and at any temperature value falling in between the above-mentioned temperature points. It should be pointed out that the facility 1000 is not excluded from carrying out of at least a part of industrial processes at temperatures below 500° C. The heat-consuming (process) facility 1000 is preferably configured as a production (manufacturing) facility and/or as a feedstock conversion facility.

The heat-consuming process(es) is/are designated by a reference numeral 101. In practice, the section 101 is a process unit configured as an industrial plant, a factory, or any industrial system comprising equipment designed to perform an industrial process or a series of industrial processes aiming at producing goods from essentially raw materials or raw energy sources. In the present disclosure, the expression “producing goods” includes, but is not limited to manufacture, extraction and/or refinement with regard to a material (such as steel or chemical compounds, in the present context) and/or power. In some embodiments, the section 101 represents a heat-consuming utility, such as a furnace or a reactor, for example, configured to carry out the heat-consuming process. In embodiments, the section 101 refers to a calcinator (also referred to as a calciner) for reacting titanium hydroxide to form titanium oxide. In some embodiments, the section 101 refers to a reactor for chlorinating ilmenite to form titanium chloride. In some embodiments, the section 101 refers to a reactor for oxidizing titanium chloride to form titanium oxide. In some embodiments, the section 101 refers to a furnace for melting minerals to form a melt configured to be spun into fibers for forming mineral-wool. In some embodiments, the section 101 refers to a lime kiln for reacting calcium carbonate to form carbon dioxide and calcium oxide in a Kraft process. In some embodiments, the section 101 refers to a Yankee Hood for dehydrating tissue paper. In some embodiments, the section 101 refers to a calcinator, oxidizer, or other reactor for producing cathodes and/or anodes for batteries. In some embodiments, the section 101 refers to a dryer for flash drying chemicals.

Section 101 can thus represent a reactor device configured to carry out a reaction or a series of reactions, optionally mediated by catalyst(s). In such an event, a heated fluidic medium generated by the rotary apparatus 100 is further directed to the (reactor) unit 101 to take part in (catalytic) reactions. The heated gas fluid/gas does not necessary transfer its thermal energy to the external process, but the heat is used to run endothermic reactions in the unit 101.

The production of the aforementioned materials has high thermal (heat) energy demand and consumption and, in conventional solutions (viz. outside the heat integration scheme 1000 presented herewith), produce considerable industrial emissions, such as carbon dioxide, into the atmosphere. The present disclosure offers apparatuses and methods for inputting thermal energy into these heat-consuming steps 101, which has high heat energy demand, whereby energy efficiency in said process(-es) can be markedly improved or the amount of air pollutants released into the atmosphere can be reduced, or both. Layout 1000 (FIG. 1) schematically outlines these improved facility and method.

In embodiments, the method comprises generation of a heated fluidic medium, such as air or oxygen, or fuel-enriched air, by virtue of a rotary heater unit 100 comprising or consisting of at least one rotary apparatus, hereafter, the apparatus 100. For the sake of clarity, the rotary heater unit is designated in the present disclosure by the same reference number, 100, as the rotary apparatus. The rotary heater unit is preferably integrated into the process facility 1000. In an embodiment, the heated fluidic medium is produced by the at least one rotary apparatus, however, in some embodiments a plurality of rotary apparatuses may be used in series or in parallel.

The rotary apparatus 100 can be provided as a standalone apparatus or as a number of apparatuses arranged in series (in sequence) or in parallel. One or more apparatuses may be connected to a common heat-consuming unit 101, such as a furnace, for example. Connection may be direct or through a number of heat exchangers.

The heat-consuming unit(s) 101 is/are provided as one or furnaces or other utilities adapted to implement processes related to manufacturing of titanium oxide, mineral-wool, gypsum, wood pulp and paper, cathodes and anodes, or flash-dried chemicals. In some configurations, thermal energy of the fluid, such as gas, heated in the at least one rotary apparatus 100 (or related unit) is used to run endothermic reactions in the heat-consuming unit 101. In such as case, the fluid heated in the apparatus(-es) 100 forms, at least partly, a process fluid of 101. In some other configurations, the fluid heated in the apparatus(-es) 100 transfers its thermal energy to a process fluid used in the heat-consuming unit(s)/process(-es) 101 to indirectly provide heat of the reaction to said process(-es). In an event of indirect heating, the fluid heated in the apparatus(-es) 100 may be same or different than the process fluid used in the heat-consuming unit(s)/process(-es) 101; however, typically it is different. For the purposes of the invention the terms “process fluid”, “process stream” or “process fluid stream” are used to indicate any one of gas, liquid, vapor, solid, including pelletized, granulized or powered materials, or a mixture thereof. In configurations which involve indirect heating, the thermal energy added into the fluid in the rotary apparatus 100 is transferred to the heat-consuming unit/process 101 through the use of so-called “heat exchanger”-type configurations represented, in the present context, with any existing fired heater, reactor or furnace, or any conventional heat exchanger device, wherein all these devices are viewed as parts of the heat-consuming units 101. In still further configurations, the fluid, such as gas, heated in the rotary apparatus(-es) 100 does not necessarily transfer its thermal energy to the heat-consuming unit 101, but the heat may be used to run endothermic reactions within same or subsequent rotary apparatus unit(s) 100 (not shown).

The heat-consuming unit(s)/utility(/ies) 101 for the manufacture of the aforementioned materials is typically one or more furnaces, reactors, kilns, calcinators, or the like. In some configurations, a number of rotary apparatus units can be connected to several heat-consuming utilities. Different configurations may be conceived, such as n+x rotary apparatuses connected to n utilities (e.g. furnaces), wherein n is equal to or more than zero (0) and x is equal to or more than one (1). Thus, in some configurations, the facility 1000 and, in particular, the rotary heater unit 100, may comprise one, two, three or four parallel rotary apparatus units connected to the common heat-consuming unit, such as a furnace, for example; the number of rotary apparatuses exceeding four (4) is not excluded. When connecting, in parallel, a number of rotary apparatuses to the common heat-consuming unit, one or more of said apparatuses 100 may have different type of drive engine, e.g. the electric motor driven reactor(s) can be combined with those driven by steam turbine, gas turbine and/or gas engine.

In an embodiment, input energy Er is conducted into the at least one rotary apparatus 100 integrated, as a (rotary) heater unit, into the process facility 1000. The input energy E_{I} preferably comprises electrical energy. In embodiments, the amount of electrical energy conducted as the input energy into the at least one rotary apparatus integrated in the heat-consuming process facility is provided within a range of about 5 to about 100 percent, preferably, within a range of about 50 to about 100 percent, as a fraction of the total energy consumed. Thus, the amount of electrical energy conducted as the input energy into the at least one rotary apparatus integrated in the heat-consuming process facility can constitute any one of: 5, 10, 15, 20, 25, 30, 35, 40, 45, 50, 55, 60, 65, 70, 75, 80, 85, 90, 95, and 100 percent (from the total energy input), or any intermediate value falling in between the above indicated points.

Electrical energy can be supplied from external or internal source(s). In practice, electrical input energy EI supplied into the apparatus can be defined in terms of electric power, the latter being defined as a rate of energy transfer per unit time (measured in Watt).

The rotary apparatus 100 of FIG. 1 is configured to receive a feed stream 1, hereafter, the feed 1. Overall, the feed 1 can comprise or consist of any fluid, such as liquid or gas or a combination thereof, provided as a pure component or a mixture of components. The feed can be a feedstock gas, a process gas, a make-up gas (a so-called replacement/supplement gas), and the like. Gaseous feed can include inert gases (air, nitrogen gas, and the like) or reactive gases, e.g. oxygen, flammable gases, such as hydrocarbons, or any other gas(-es) like hydrogen and ammonia. Selection of the feed is process-dependent; that is, the nature of the heat-consuming process 101 (and indeed a specific industry/an area of industry said heat-consuming process 101 is assigned to) implies certain requirements and/or limitations on the selection of feed substance(s).

It is preferred that the feed 1 enters the apparatus 100 in essentially gaseous form. Preheating of the feed or conversion of liquid or essentially liquid feed(s) into a gaseous form can be performed in an optional preheater unit 102 configured as a (pre) heater apparatus or a group of apparatuses. In the preheater unit 102, the feed stream(s) originally provided in a gaseous form (e.g. the process gas or gases) can be further heated (e.g. superheated). In the preheater unit 102, the feed 1 can be vaporized if not already in gas form and optionally superheated.

The preheater unit 102 can be any conventional device/system configured to provide heat to fluidic substance. In some configurations, the preheater unit 102 can be a fired heater (e.g. a direct-fired heat exchanger that uses hot combustion gases (flue gases) to raise the temperature of a fluidic feed, such as a process fluid, flowing through the coils arranged inside the heater). Additionally or alternatively, the preheater unit 102 can be configured to exploit energy made available by the other units in the heat-consuming facility (for example by extracting thermal energy from a hot stream 13 arriving from heat recovery 104). The preheater unit 102 can thus be configured to utilize other steam streams, as well as electricity and/or waste heat streams (not shown).

Depending on a heat-consuming process 101 and related equipment, the feed stream 1 used to produce the heated fluidic medium, such as for example air, by virtue of the rotary heater unit, namely, apparatus(-es) 100, comprises a virgin feed (fresh feed) and/or recycle stream(s). Hence, the feed 1 may consist of any one of fresh feed, recycle (fluidic) stream, and a mixture thereof. Stream 2 representing (pre)heated feed may include, in addition to feed 1, all recycle streams, such as those arriving from a purification section 105 and/or a heat recovery section 104.

In the rotary heater unit/the rotary apparatus 100, the temperature is raised to a level which is required by the heat-consuming process 101 or to a maximum level achieved by the rotary apparatus. In an event the temperature rise achieved by the rotary apparatus 100 is not sufficient for the heat-consuming process and/or if, for example, the temperature of the fluid needs to be raised again after it has transferred its heat to the heat-consuming process 101, further temperature rise can be achieved by virtue of arranging additional heater units (100B, 103), further referred to as “booster” heater(s), downstream of a primary rotary heater unit 100 (100A); rf. description to FIG. 2B. Each said additional heater unit comprises or consists of an additional heating apparatus implemented according to the description below.

In heat-consuming processes 101, the main sources of heat consumption are heating of working fluids and/or associated equipment and endothermic reactions (reactions that require external energy to proceed). In some applications it is also feasible to recover heat from heat-consuming processes 101. Heat recovery section is indicated on FIG. 1 with ref. no. 104. Recovered heat can be further used for heating the feed stream 1 and/or a recycle stream (separate recycle stream is indicated on FIG. 1 with ref. no. 11).

Before or after the preheater 102, the heat recovery section 104 can be arranged to recover heat from hot fluidic medium that may be further utilized to heat the feed stream 1 and the recycle stream 11.

Section 104 represents a heat recovery unit, configured to recover heat from the process streams arriving to section 104 from the heat-consuming unit (section 101). Heat recovery may be arranged through collecting the gases exiting the process unit 101 at atmospheric pressure over the process liquids and recycling these gases to the preheater unit 102 and/or the rotary heater unit/the rotary apparatus 100. The heat recovery installation 104 may be represented with at least one heat exchanger device (not shown). For example, in closed gas systems heat recovery can be arranged by feasible heat exchanger arrangements. Heat exchangers based on any appropriate technology can be utilized. Heat recovery may be optional for heating feed gas if the heat is consumed elsewhere or if it is not possible to recover heat due to safety reasons or any other reasons.

In the facility layout 1000, the heat recovery unit 104 can be arranged before and/or after the preheater 102. In the latter configuration, the heat recovery unit 104 is arranged to recover heat from the hot fluidic medium (stream 5) flowing from the manufacturing process 101, which may be further utilized to heat the feed stream 1 and recycle stream 11. On the other hand, when the heat recovery unit 104 is arranged before the preheater 102, feed 1 is first led to the unit 104 (as stream 12) and then returned to preheating 102 as stream 13. In such a case, unit 104 acts as a first preheater.

In some instances, gases require purification, e.g. from dust and fine particles, before being directed to heat recovery. Purification can be done by a series of filters, for example, arranged before the heat recovery section 104 (not shown). Additionally or alternatively, gases exiting the process unit 101 may be directed to a purification unit 105 (i.e. bypassing the heat recovery unit 104), and, after purification, returned to heat recovery (not shown).

Heat recovery is optional for heating feed gas if the heat is consumed elsewhere or if it is not possible to recover heat due to safety or any other reason.

Process gas may contain, in addition to valuable products, also unwanted impurities and side products which may accumulate in or/and be harmful for the rotary heater apparatus(-es) 100, 103 and/or the process units 101 through causing corrosion and poisoning catalytic beds. Purification and separation of streams discharged from heat-consuming processes 101 is performed in the purification unit 105. Purification unit 105 is configured to separate recycle products or waste gas or other impurities from a recycle gas. Purification and separation methods vary dependent on the nature of the heat-consuming process 101 Unit 105 can comprise a number of appliances, such as filters, cyclones etc., adapted to mechanically remove dust and solid particles. Any conventional purification/separation methods and devices may be utilized. Exemplary purification/separation methods include, but are not limited to: cryogenic separation methods, membrane processes, Pressure Swing Adsorption (PSA), distillation, absorption, and any combination of these methods. The unit 105 may also comprise device(s) configured to increase gas pressure by compression, for example. Typically, purification units 105 operate at lower temperatures than process units 101; therefore, prior to entering the purification unit, a product gas stream is cooled down (in the heat recovery 104, for example). To minimize the extent of deterioration of reactor beds in 101, it is also important to control composition of recycle gas 11. Purification unit 105 may also comprise appliances configured to increase gas pressure by compression, for example.

Purification unit 105 can be further adapted to purify waste gas(es), e.g. carbon dioxide, for further carbon capture. Waste gases discharged from the production facility as stream 7 (FIG. 1) can thus be further directed to carbon capture (not shown). Suitable methods for purification of waste gases include for example PSA, distillation, absorption, etc.

Heated fluidic medium required for carrying out the heat-consuming process(es) 101 is generated by virtue of at least one rotary apparatus 100.

In an embodiment, the heated fluidic medium is generated in the rotary apparatus 100, where an amount of thermal energy is added directly into fluidic medium propagated through said apparatus. In such an event, the heated fluidic medium generated in the rotary apparatus may be for example a process gas, such as a hydrocarbon-containing gas (e.g. methane) (see FIG. 1, streams 1-4, particularly stream 2), while the hot fluidic medium 5 that exits the heat-consuming unit 101 may represent a product-containing stream. In direct heating, streams 1-5 relate to a working- or process fluid.

The heated fluidic medium generated in the rotary apparatus can be further used as a carrier to transfer thermal energy to the heat-consuming unit 101 configured to implement or mediate a heat-consuming process or processes (101). For example, an inert gas such as air, nitrogen or steam (H₂O) can be heated in the rotary apparatus 100 and further used to convey the heat generated by the rotary apparatus to a furnace adapted to perform the process 101. In this regard, generation of a heated medium (e.g. fluidic or solid streams exploited by the process 101) can be performed outside the rotary apparatus through a process of heat transfer between the heated fluidic medium generated in the rotary apparatus and a suitable medium exploited by the process 101 and thus bypassing the rotary apparatus. FIG. 1 thus shows stream 9 (a process stream) bypassing the rotary apparatus 100 and designating, in present context, the feed/process stream, while streams 1-4 arriving to the process unit 101 via the rotary heater 100 designate fluidic medium (e.g. air, nitrogen, steam or other inert heating media) directed to the process unit 101 for heating the “cold” process stream 9. Use of inert hot gases as heating media in indirect heating applications may be preferred when the process streams to be heated are at high pressure or under vacuum. Stream 10 represents a “hot” process stream and/or a product stream, respectively.

In embodiments, the method comprises generation of a heated fluidic medium by virtue of a rotary heater unit comprising or consisting of at least one rotary apparatus 100. The rotary heater apparatus 100 is preferably integrated into the heat-consuming facility/feedstock conversion facility 1000 as described in the present disclosure. In an embodiment, the heated fluidic medium is produced by the at least one rotary apparatus; however, a plurality of rotary apparatuses may be used in series (in sequence) or in parallel.

In embodiments, the disclosed method comprises generation of a heated fluidic medium by at least one rotary apparatus 100 integrated into related facility 1000, the at least one rotary apparatus comprising: (a) a rotor with a plurality of rotor blades arranged into at least one row around a rotor hub mounted onto a rotor shaft; (b) a plurality of stationary blades or vanes arranged into an assembly adjacent to the at least one row of rotor blades; and (c) a casing with a duct formed between at least one inlet and at least one outlet, the duct configured to encompass rotating and stationary blades such that bladeless portion(s) of the duct is/are arranged essentially subsequently to bladed portions thereof, wherein the rotary apparatus is configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

The rotary apparatus 100 configured for generating the heated fluidic medium to be supplied into the production facility according to the embodiments described above thus comprises a rotor comprising a plurality of rotor blades arranged into at least one row over a circumference of a rotor hub or a rotor disk mounted onto a rotor shaft, and a casing with at least one inlet and at least one outlet, the rotor being enclosed within the casing. In the rotary apparatus 100, an amount of thermal energy is imparted to a stream of fluidic medium directed along a flow path formed inside the casing between the inlet and the outlet by virtue of a series of energy transformations occurring when said stream of fluidic medium passes through the at least one row of rotor blades when propagating inside the casing of the rotary apparatus, between the inlet and the outlet, whereby a stream of heated fluidic medium is generated.

Implementation of the rotary apparatus 100 may generally follow the disclosures of a rotary reactor apparatus according to the U.S. Pat. No. 7,232,937 (Bushuev), U.S. Pat. No. 9,494,038 (Bushuev) and U.S. Pat. No. 9,234,140 (Seppälä et al), and of a radial reactor apparatus according to the U.S. Pat. No. 10,744,480 (Xu & Rosic), the entire contents of which are incorporated by reference herewith. Any other implementation, which can be configured to adopt the method according to the embodiments, can be utilized.

In the patent documents referenced above, the rotary turbomachine-type apparatuses were designed as reactors for processing hydrocarbons, in particular, for steam cracking. General requirements for these applications are: rapid heating of gases, high temperature, short residence time, and plug flow (a flow model which implies no axial mixing). These requirements have led to designs where the turbomachine type reactors have several heating stages accommodated in a relatively small volume.

The present disclosure is based on an observation that the rotary apparatus (including, but not limited to the ones referenced above) can be electrified and used as a heater to generate the heated fluidic medium further supplied in the heat-consuming process 101, such as a process or processes related to manufacturing of titanium oxide, mineral-wool, gypsum, wood pulp and paper, cathodes and anodes, or flash-dried chemicals. By integration of the rotary apparatus heater unit(s) into the heat-consuming process or processes, significant reductions in greenhouse gas- and particle emissions can be achieved. By way of example, the rotary apparatus can replace fuel-fired heaters in a variety of applications (described hereinbelow). The temperature range can be extended from about 1000° C. (generally achievable with the above referenced reactor devices) to up to at least about 1700° C. and further up to 2500° C. Construction of the rotary apparatuses capable of achieving these high temperatures is possible due to an absence of aerodynamic hurdles.

In described facilities 1000, the rotary apparatus(-es) 100 can be retrofitted with existing equipment, such as furnaces, reactors and reactor systems, as described herewith.

The rotary apparatus 100 integrated into the heat-consuming (process) facility/feedstock conversion facility according to the embodiments and configured to generate the heated fluidic medium for the method(s) according to the embodiments thus comprises a rotor shaft positioned along a horizontal (longitudinal) axis with at least one rotor unit mounted onto the rotor shaft. The rotor unit comprises a plurality of rotor blades (also referred to as rotating or working blades) arranged over the circumference of a rotor hub or a rotor disk and together forming a rotor blade cascade. The rotary apparatus 100 thus comprises a plurality of rotor blades arranged into at least one row around the rotor hub/rotor disk mounted onto the rotor shaft, and forming an essentially annular rotor blade assembly or rotor blade cascade.

In embodiments, the apparatus 100 further comprises a plurality of stationary blades or vanes arranged into an assembly adjacent to at least one row of the rotor blades. With the term “stationary” we refer to non-rotating blades/vanes (as contrary to the rotor blades). It is noted that attachment of stationary vanes to the casing (internal wall or lining thereof) may be fixed (non-movable) or essentially movable. In a latter case attachment of stationary vane (-s) may employ some degree of movement, allowing adjustment of the blade angle, to some extent, with regard to the rotor blades and/or the interior of the casing. Stationary blades/vanes may be attached directly to the casing (internal wall and/or lining thereof) or via auxiliary connector means such as for example rails, ring-shaped support frame, etc. Movable connection may be realized by hinged joints, or any other appropriate connection means.

In embodiments, said rotating and stationary blades are encompassed within an apparatus casing, in where a duct is formed, thus forming bladed portions of the duct. In embodiments, said rotating and stationary blades are arranged in the duct such that bladeless portions are formed, in the duct, essentially subsequently to stationary blades and/or rotating vanes. In embodiments, said bladeless portion(s) of the duct is/are arranged essentially subsequently to bladed portions thereof.

The rotary apparatus is thus configured to impart an amount of thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated.

In some embodiments, the plurality of stationary vanes can be arranged into at least one stationary vane cascade, provided as an essentially annular assembly upstream and/or downstream of the at least one row of rotor blades.

A plurality of stationary vanes arranged into the assembly disposed upstream of at least one row of the rotor blades may be provided as stationary guide vanes (GV), such as inlet guiding vanes (IGV), and be configured, in terms of profiles, dimensions and disposition thereof around the central shaft, to direct the fluid flow into the rotor in a predetermined direction such, as to control and, in some instances, to maximize the rotor-specific work input capability.

In embodiments, the rotary apparatus 100 further comprises a diffuser area arranged downstream of at least one row of the rotor blades (rotor blade cascade). The diffuser area can be configured with or without stationary (diffuser) vanes. Hence, the diffuser area may be provided as an essentially bladeless portion of the duct or as a bladed portion of the duct. In a latter case the diffuser area comprises a vaned diffuser implemented as a plurality of stationary blades or vanes arranged into a diffuser vane cascade, provided as an essentially annular assembly downstream of the rotor. In some configurations, the diffuser area may encompass a vaneless diffuser.

The rotary apparatus can be configured with two or more essentially annular rows of rotor blades (rotor blade cascades) sequentially arranged on/along the rotor shaft. In such an event, the stationary guide vanes may be installed upstream of the first row of the rotor blades, upstream of each row of rotor blades in the sequence, or upstream of any selected row of rotor blades in a sequential arrangement of the latter; and the stationary diffuser vanes may be installed downstream of the first row of the rotor blades, downstream of each row of rotor blades in the sequence, or downstream of any selected row of rotor blades in a sequential arrangement of the latter.

The rotor and the stationary blades (IGV and/or diffuser blades) are enclosed within an internal passageway (the duct) formed in the casing.

The diffuser area provided as an essentially bladeless portion of the duct is described in more detail in U.S. Pat. No. 10,744,480 to Xu and Rosic. In such configuration, provision of the diffuser device (whether vaned or vaneless) may be omitted, and diffuser area may be represented with the essentially bladeless portion of the duct (a so-called vaneless space) located downstream of the rotor and configured, in terms of its geometry and/or dimensional parameters, to diffuse a high-speed fluid flow arriving from the rotor.

Overall, provision of the bladeless/vaneless portion of the duct is common for all configurations of the rotary apparatus 100 described above. Depending on configuration, said bladeless portion is arranged subsequently (downstream) to the rotor blades (rf. U.S. Pat. No. 10,744,480 to Xu and Rosic) or subsequently (downstream) to stationary diffuser blades (rf. U.S. Pat. No. 9,494,038 to Bushuev and U.S. Pat. No. 9,234,140 to Seppälä et al). In some configuration described for example by Seppälä et al, arrangement of rotating and stationary blade rows in the internal passageway within the casing is such that bladeless portion(s) is/are created between an exit from the stationary diffuser blades disposed downstream of the rotor blades and an entrance to the stationary guide blades disposed upstream of the rotor blades of a subsequent rotor blade cascade unit.

The terms “upstream” and “downstream” refer hereby to spatial and/or functional arrangement of structural parts or components with relation to a predetermined part- or component, hereby, the rotor, in a direction of fluidic flow stream throughout the apparatus (from inlet to outlet). In some configurations, the at least one row of rotor blades (working blades) can be positioned between the rows of stationary (stator) vanes arranged into essentially annular assemblies (referred to as cascades) at one or both sides of the working blade row. Configurations including two or more rows of rotor blades/rotor blade cascades arranged in series (in sequence) on/along the rotor shaft may be conceived with or without stationary blades in between. In an absence of stationary vanes between the rotor blade rows, the speed of fluidic medium propagating through the duct increases in each subsequent row. In such an event, a plurality of stationary vanes may be arranged into assemblies upstream of a first rotor blade cascade in said sequence (as stationary guide vanes) and downstream of a lastmost rotor blade cascade (as stationary diffuser vanes).

The row of rotor blades (the rotor blade cascade) and a portion of the duct downstream said rotor blades enclosed inside the casing optionally provided with an assembly of stationary diffuser vanes within the diffuser area) may be viewed as a minimal process stage (hereafter, the stage), configured to mediate a complete energy conversion cycle. Hence, an amount of kinetic energy added to the stream of fluidic medium by at least one row of rotating blades is sufficient to raise the temperature of the fluidic medium to a predetermined value when said stream of fluidic medium exits the rotor blades and propagates, in the duct, towards a subsequent row of rotor blades, or enters the same row of rotor blades following an essentially helical trajectory formed within the essentially toroidal-shaped casing. Hence, thermal energy is added to the stream of fluidic medium flowing in the duct between the at least one inlet and the at least one outlet by virtue of converting mechanical energy of rotating blades of the rotor into internal energy of the fluid (whereby thermal energy is added to the fluidic stream) when said fluidic stream successively passes through bladed and bladeless portions of the duct. The duct (which encloses the periphery of the rotor) is preferably shaped such, that upon propagation of the fluidic stream in the duct, the stream decelerates and dissipates kinetic energy into an internal energy of the fluidic medium, and an amount of thermal energy is added to the stream of fluidic medium.

The stationary guide blade row(s) disposed upstream of the at least one row of rotor blades prepare required flow conditions at the entrance of the rotating blade row (cascade) during the energy conversion cycle.

In some configurations, the process stage is established with the assembly of stationary guide vanes (upstream of the rotor blades), the row of rotor blades and the diffuser area arranged downstream of said rotor blades, the diffuser area provided as the essentially vaneless portion of the duct optionally supplied with diffuser vanes. During the energy conversion cycle, enabled with successive propagation of the stream of fluidic medium through the stationary guide vanes, the at least one row of rotor blades and the diffuser area, respectively, in a controlled manner, mechanical energy of the rotor shaft is converted into kinetic energy and further-into internal energy of the fluid, followed by the rise of fluid temperature. An amount of kinetic energy added to the stream of fluidic medium by rotating blades of the rotor is sufficient to raise the temperature of the fluidic medium to a predetermined value when said stream of fluidic medium exits the rotor blades and passes, inside the duct, through the diffuser area, whereupon the stream decelerates and dissipates kinetic energy into an internal energy of the fluidic medium, and an amount of thermal energy is added to the stream of fluidic medium. In the rotor blade row, the flow accelerates, and mechanical energy of the shaft and rotating blades is transferred to fluidic stream. In at least part of each rotor blade row the flow may reach a supersonic flow condition. In the diffuser area, the high-speed fluid flow arriving from the rotor is diffused with the significant entropy increase, whereby the flow dissipates kinetic energy into the internal energy of the fluidic substance, thus providing thermal energy into the fluid. If the flow upstream of the diffuser is supersonic, the kinetic energy of the fluidic stream is converted into internal energy of the fluid through a system of multiple shocks and viscous mixing and dissipation. An increase in the internal energy of the fluid results in a rise of fluid temperature. The energy conversion function may be performed by the vaneless portion of the duct located downstream of the rotor blades (rf. U.S. Pat. No. 10,744,480 to Xu & Rosic) and/or by an assembly of diffusing vanes, for example (rf. U.S. Pat. No. 9,234,140 to Seppälä et al).

The rotary apparatus 100 can be configured as a multistage- or a single-stage solution. Multistage configurations can be conceived comprising a number of rotor units (e.g. 1-5 rows of rotor blades sequentially arranged on/along the rotor shaft) alternating with bladeless area(s). In some configurations, the bladeless area(s) may be referred to as (bladeless) diffuser areas. In some configurations, the bladeless area(s) (bladeless portions of the ducts) may be arranged subsequently to stationary blades, such as stationary diffuser blades.

In an exemplary configuration outlined in U.S. Pat. No. 9,234,140 to Seppälä et al, the rotary apparatus 100 can be implemented substantially in a shape of a ring torus, where a cross-section of the duct in the meridian plane forms a ring-shaped profile. The apparatus comprises a rotor unit disposed between stationary guide vanes (nozzle vanes), and stationary diffusing vanes. The stages are formed with rows of stationary nozzle vanes, rotor blades and diffusing vanes, through which the fluidic stream propagates, in a successive manner, following a flow path established in accordance with an essentially helical trajectory. In this configuration, fluidic stream circulates through the rotating rotor blade cascade a number of times while propagating inside the apparatus between the inlet and the exit. Similar ring-shaped configuration is described in U.S. Pat. No. 9,494,038 to Bushuev.

In another exemplary configuration outlined in U.S. Pat. No. 9,234,140 to Seppälä et al, the rotary apparatus 100 can be configured as an essentially tubular, axial-type turbomachine. In such configuration, the apparatus comprises an extended (elongated) rotor hub, along which a plurality of rotor blades is arranged into a number of sequential rows. The rotor is enclosed within the casing, inner surface of which is provided with the stationary (stator) vanes and diffuser vanes, arranged such that blades/vanes of the stator, rotor- and diffuser cascades alternate along the rotor hub in a longitudinal direction (along the length of the rotor shaft, for inlet to exit). Blades of the rotor cascade at certain position along the rotor in the longitudinal direction form the stage with the adjacent pairs of stationary guide (nozzle) vanes and diffusing vanes, respectively.

In described configurations, the subsequent stages have blade/vane-free space between them.

In still another exemplary configuration outlined in U.S. Pat. No. 10,744,480 to Xu and Rosic, the rotary apparatus 100 can be configured as a radial turbomachine that generally follows a design for centrifugal compressors or centrifugal pumps. The term “centrifugal” implies that fluid flow within the device is radial; therefore, the apparatus may be referred, in the present disclosure, as a “radial-flow apparatus. The apparatus comprises a number of rotor units mounted onto elongated shaft, wherein each rotor unit is preceded with stationary guide vanes. A vaneless portion of the duct shaped in a manner enabling energy conversion (U-bend or S-bend, for example) is located after the rotor unit(s). Additionally, configuration may comprise a separate diffuser device (vaned or vaneless) disposed downstream of the rotor.

In all configurations described above, the rotary apparatus 100 performs, in the method disclosed herein, in similar manner. In operation, input energy conducted into the at least one rotary apparatus integrated into the heat-consuming facility/the feedstock conversion facility is converted into mechanical energy of the rotor. Conditions in the rotary apparatus are adjusted such, as to produce flow rate conditions, at which an amount of kinetic energy added to the stream of fluidic medium by rotating blades of the rotor is sufficient to raise the temperature of the fluidic medium to a predetermined value when said stream of fluidic medium exits the at least one row rotor blades and passes through the duct and/or through the diffuser area to enter the subsequent row of rotor blades or the same row of rotor blades in accordance to the description above. The row(s) of rotor blades may be preceded with stationary guide vanes. Hence, adjustable conditions comprises adjusting at least a flow of fluidic medium propagating inside the casing of the rotary apparatus, between the inlet and the exit (outlet). Adjusting the flow may include adjusting such apparatus operation related parameters, as temperature, mass flow rate, pressure, etc. Additionally or alternatively, flow conditions can be adjusted by modifying shape of the duct formed inside the casing.

In some exemplary configurations, the rotary apparatus 100 can be configured to implement a fluidic flow between its inlet(s) and outlet(s) along a flow path established in accordance with any one of: an essentially helical trajectory formed within an essentially toroidal-shaped casing, as discussed in any one of the patent documents U.S. Pat. No. 9,494,038 to Bushuev and U.S. Pat. No. 9,234,140 to Seppälä et al; an essentially helical trajectory formed within an essentially tubular casing, as discussed in the patent document U.S. Pat. No. 9,234,140 to Seppälä et al; an essentially radial trajectory as discussed in the patent document U.S. Pat. No. 10,744,480 to Xu & Rosic; and along the flow path established by virtue of the stream of fluidic medium in the form of two spirals rolled up into vortex rings of right and left directions, as discussed in the patent document U.S. Pat. No. 7,232,937 to Bushuev). In some configurations, the rotary apparatus is configured to implement a fluidic flow between its inlet(s) and outlet(s) along a flow path essentially parallel to a rotor shaft enclosed in an essentially tubular casing. The aerodynamic design of the rotary apparatus can vary.

The rotary apparatus 100 utilizes a drive engine. In preferred embodiments, the apparatus utilizes electrical energy as the input energy and is therefore electric motor-driven. For the purposes of the present disclosure, any appropriate type of electric motor (i.e. a device capable of transferring energy from an electrical source to a mechanical load) can be utilized. Suitable coupling(s) arranged between a motor drive shaft and the rotor shaft, as well as various appliances, such as power converters, controllers and the like, are not described herewith. Additionally, the rotary apparatus can be directly driven by gas- or steam turbine, for example, or any other appropriate drive device. In layouts involving parallel connection of a number of rotary apparatuses 100 to a common heat-consuming unit 101, such as a furnace, for example, one or more of said apparatuses may utilize different type of drive engine, e.g. the electric motor driven apparatuses can be combined with those driven by steam turbine, gas turbine and/or gas engine.

Electric power (defined as the rate of energy transfer per unit time) can be supplied into the rotary apparatus through supplying electric current to the electric motor used to propel a rotary shaft of the apparatus. Supply of electric power into the rotary apparatus can be implemented from an external source or sources (as related to the rotary heater unit/the apparatus 100 and/or the heat-consuming process facility 1000). Additionally or alternatively, electrical energy can be produced internally, within the facility 1000.

An external source or sources include a variety of supporting facilities adapted for sustainable energy production. Thus, electric power can be supplied from an electricity generating system that exploits at least one source of renewable energy or a combination of the electricity generating systems exploiting different sources of renewable energy. External sources of renewable energy can be provided as solar, wind- and/or hydropower. Thus, electric power may be received into the process from at least one of the following units: a photovoltaic electricity generating system, a wind-powered electricity generating system, and a hydroelectric power system. In some exemplary instances, a nuclear power plant may be provided as the external source of electrical power. Nuclear power plants are generally regarded as emission-free. The term “nuclear power plant” should be interpreted as using traditional nuclear power and, additionally or alternatively, fusion power.

Electricity can be supplied from a power plant that utilizes a turbine as a kinetic energy source to drive electricity generators. In some instances, electric power to drive the at least one apparatus 100 can be supplied from at least one gas turbine (GT) provided as a separate installation or within a cogeneration facility and/or a combined cycle power facility, for example. Electric power can thus be supplied from at least one of the following units: a combined cycle power facility, such as a combined cycle gas turbine plant (CCGT), and/or a cogeneration facility configured for electricity production combined with heat recovery and utilization through combined heat and power (CHP), for example. In some examples, the CHP plant can be a biomass fired plant to increase the share of renewable energy in the process described. Additionally or alternatively, supply of electric power can be realized from a spark ignition engine, such as a gas engine, for example, and/or a compression engine, such as a diesel engine, for example, optionally provided as a part of an engine power plant. Still further, any conventional power plant configured to produce electrical energy from fossil raw materials, such as coal, oil, natural gas, gasoline, and the like, typically mediated with the use of steam turbines, can be used to generate electrical energy as an input energy for the rotary apparatus 100. Also hydrogen can be utilized as a source of renewable energy, to be reconverted into electricity, for example, using fuel cells.

Any combination of the abovementioned sources of electric power, realized as external and internal sources, may be conceived. Importing low emission electric power from an alternative (external) source improves energy efficiency of the heat-consuming process facility.

Conducting input energy, which comprises electrical power, into a drive engine of the rotary apparatus 100 can be further accompanied with conducting mechanical shaft power thereto from a power turbine, for example, optionally utilizing thermal energy generated elsewhere in the facility 1000 or outside said facility. Shaft power is defined as mechanical power transmitted from one rotating element to another and calculated as a sum of the torque and the speed of rotation of the shaft. Mechanical power is defined, in turn, as an amount of work or energy per unit time (measured in Watt).

In practice, the shaft power from the electric motor and the power turbine, for example, can be divided so that any one of those can provide the full shaft power or a fraction of it.

With reference back to FIG. 1, section 103 represents a so-called additional- or booster heating (see also description to FIGS. 2B, 2C). Booster heating is an optional method to (additionally) heat a fluidic medium, such as a process gas, for example, beyond capability of the rotary apparatus 100. Thus, the booster heating may be employed to heat the fluidic medium to the temperatures exceeding 1700° C. Temperature boosting can be achieved by virtue of adding reactive gases 8 (burning gases or reactants, e.g. hydrogen, hydrocarbons, other reactive gases, ammonia, oxygen, air, etc.) into the gaseous medium stream directed through the booster section 103 (the medium being already heated in the heater section 100). In the booster section 103, by virtue of exothermic reactions, the temperature will rise to a level, which is not possible to achieve by a single rotary apparatus. For example, a fuel gas, such as hydrogen, can be introduced into an oxygen-containing process gas, such as air. At elevated temperatures, hydrogen and oxygen enter an exothermic reaction to produce water molecules (hydrogen combustion).

The booster heater(s) can be used for example in an event, when the temperature of the fluid once heated in the rotary apparatus(es) 100, needs to be raised again after it has transferred its heat to the heat-consuming process. An example of this is a series of successive catalytic endothermic reactors, where the temperature drops reactor-wise and needs to be raised again between the reactors (described with relation to FIG. 2E).

Additionally or alternatively, temperature boosting can be achieved by virtue of arranging an additional, separate “booster” heater apparatus (100B) downstream a “primary” heater apparatus (100A), for details, see description to FIGS. 2B-2D. Apparatuses 100A, 100B may be identical and vary in terms of size or internal design.

Hence, the booster section 103 can comprise at least one rotary apparatus 100 (see FIGS. 2C, 2E).

Additionally or alternatively, a stream containing reactive or inert gases 8 can be fed to the rotary apparatus 100 (not shown) or to any equipment downstream of said apparatus (e.g. into the heat-consuming process section 101) (not shown). Thus, the reactive gases 8 may also be injected directly to the heat-consuming process unit 101, if the latter is configured as the heat-consuming utility, such as a reactor. In a number of applications, a support fuel (8) may be injected directly to the process unit 101 to generate heat and/or to take part in the reactions. One example is reduction of iron ore by methane or hydrogen in a blast furnace (as discussed in more detail further below).

FIGS. 2A-2F show exemplary layouts for the rotary apparatus 100 representing the rotary heater unit or units within the facility 1000 with regard to the preheater unit 102, acting, in some instances, also as a heat recovery unit, and the temperature booster section 103. The following citations are used for the members: 100, 100A, 100B. Rotary heater unit(s) (rotary apparatus(es)); 101. Heat-consuming unit/process; 102. Preheater unit; 103. Additional heating apparatus (booster heater).

FIG. 2A schematically illustrates a basic implementation for the rotary apparatus 100 configured to input heat into a stream of a fluidic medium (feed stream 1) directed therethrough. Heated stream exiting the apparatus 100 is designated with reference number 2, respectively. In basic implementation, the rotor system of the rotary apparatus 100 is aerodynamically configured so that a volume of fluid is heated to a predetermined temperature while propagating along the flow path formed in the casing of the apparatus 100, between the inlet and exit (so called “one-pass” implementation). The apparatus 100 enables temperature rise (delta T, ΔT) within a range of about 10° C. to about 120° C., in some configurations—up to about 500° C., in one process stage. Hence, in case of a multistage implementation, the fluid can be heated to 1000° C. in “one-pass” implementation (taken 100° C. temperature rise per stage in a 10-stage apparatus). Since residence time the fluidic medium spends to pass through the apparatus process stage is in a scale of fractions of seconds, such as about 0.01-1.0 milliseconds, fast and efficient heating can be achieved already in a basic configuration. Temperature rise can be optimized as required.

FIG. 2B illustrates a basic concept involving so-called additional or booster heating. Booster heating is an optional method to heat a fluidic medium, such as a process gas, for example, beyond capability of a standalone heater apparatus 100.

Temperature boost may be viewed as thermal, chemical or both. In a first configuration (a) also referred to as a “thermal boost”, an additional rotary heater apparatus (designated as 100B on FIGS. 2B, 2C and 2D) is arranged downstream of a “primary” rotary heater apparatus (designated as 100A on FIGS. 2B, 2C and 2D). Apparatuses 100A, 100B are generally recognized, within the present disclosure, as rotary heater units 100. Generation of the heated fluidic medium is can thus be achieved by provision of at least two sequentially connected rotary apparatuses 100A, 100B, wherein the stream of fluidic medium (rf. feed stream 1) is heated to a predetermined temperature in at least a first rotary apparatus (100A) in a sequence, referred to hereby as a primary heater, and wherein said stream of fluidic medium (rf. stream 2) is further heated in at least a second rotary apparatus (100B) in the sequence by inputting an additional amount of thermal energy into the stream of fluidic medium “preheated” in the first rotary apparatus 100A and propagating through the second rotary apparatus 100B (rf. stream 3). The apparatus 100B is therefore referred to as a booster heater. The apparatuses 100A, 100B may be identical or vary in terms of size or internal design. A sequence of two or more booster apparatuses such as 100B can be arranged after a primary heater 100A. Booster apparatuses can be arranged in parallel or in series, or in any combination that allows for optimization of rotating speed and aerodynamics thereof.

In a second, additional or alternative, configuration (further referred to as “chemical boost”), the additional heating apparatus designated as 103 (FIGS. 1, 2B) is adapted to receive, into the stream of fluidic medium propagating therethrough, reactive components 5, such as for example combustible fuel, to provide heat by exothermic reactions prior to directing said stream of fluidic medium to the heat-consuming process 101. In this configuration, temperature boosting can be achieved by virtue of introducing (e.g. by injecting) a reactive chemical or chemicals 5 into to the stream of fluidic medium directed through the additional heater unit/heating apparatus 103. It is noted that stream 5 of FIG. 2B corresponds to stream 8 shown on FIG. 1.

The reactive chemical-based booster heater unit 103 may be located after the thermal booster heater unit 100, 100B (FIG. 2B) or directly after the primary heater 100, 100A (FIG. 1). The reactive chemical (reactant) 5 may include combustion gases, such as hydrogen gas, hydrocarbons, ammonia, oxygen, air, other gas and/or any other appropriate reactive compound, optionally a catalyst. In the unit 103, by virtue of exothermic reactions, the fluidic stream can be heated to a level, which is typically not possible to achieve by a single rotary apparatus 100 not involving chemical-mediated heating (rf. stream 4). For example, a fuel gas, such as hydrogen, can be introduced into an oxygen-containing process gas, such as air. At elevated temperatures, hydrogen and oxygen enter an exothermic reaction to produce water molecules (hydrogen combustion).

Fuel gas can be injected into the booster heater unit 103 through burners along with air (or enriched oxygen) to rise the temperature of gases. If heated gas contains flammable gases and it is possible to consume these gases for heating only air/or oxygen can be added. Process gases can contain H₂, NH₃, CO, fuel gases (methane, propane, etc.) which may be burned to generate heat. Other reactive gases can be injected to generate heat if feasible.

The additional heater 103 adapted for chemical boost may be configured as a piece of pipe or as a chamber where exothermic reactions take place, and/or it can comprise as at least one rotary apparatus 100 arranged to receive reactive compounds to accommodate exothermic reactions to produce additional heat energy. The booster section 103 can thus comprise at least one rotary apparatus 100. Optionally, the reactive chemicals can be injected directly to the heat consuming process 101 (not shown). Additionally or alternatively, the reactive chemical mediated boost can be implemented in a single apparatus 100, 103, modified accordingly.

In an arrangement involving booster heating, the temperature of the stream of fluidic medium preheated to a predetermined temperature in a first rotary apparatus (100A) can be further raised to a maximum limit in subsequent heater units (100B, 103). By way of example, the temperature of the stream of fluidic medium preheated to about 1700° C. in a primary heater (100A) can be further raised in subsequent heater units (100B, 103) up to 2500° C. and beyond.

Mentioned concepts can be used separately or in combination, so that the reactive chemical 5 can be introduced into any one of the apparatuses 100 connected in parallel or in series (in sequence). Provision of the booster heater(s) is optional.

In additional or alternative configurations, preheating and additional heating can be implemented in the same apparatus 100 (not shown). This can be achieved in multistage configurations, comprising a number of rotor units (e.g. 1-5 rows of rotor blades sequentially arranged on/along the rotor shaft) alternating with common diffuser area(s) (vaneless or vaned).

Additionally or alternatively, booster heating can be used for example in an event, when the temperature of the fluid once heated in the rotary apparatus(es) 100, needs to be raised again after it has transferred its heat to the heat-consuming process 101. Exemplary configuration comprising a number of rotary heater apparatuses 100 (100A, 100B and/or optionally 103) alternating with the heat-consuming units 101 is shown on FIG. 2E. Such configuration can be utilized in an event when the temperature drop occurs in each unit 101 and it needs to be raised again between the units 101. The arrangement of FIG. 2E may be beneficial for a series of successive catalytic endothermic reactors (representing hereby heat-consuming units 101), where the temperature drops reactor-wise and has to be increased again between the reactors.

Upon connecting at least two rotary apparatuses, such as 100A, 100B, and optionally 103 (in an event 103 is implemented as a rotary apparatus 100) in parallel or in series, a rotary apparatus assembly can be established (see for example FIGS. 2B-2D). Connection between the rotary apparatuses 100 implemented as “primary” heater(s) 100A or “booster” heater(s) 100B, 103 can be mechanical and/or functional. Functional (in terms of achievable heat input, for example) connection can be established upon association between at least two individual, physically integrated- or non-integrated individual apparatus units. In a latter case, association between the at least two rotary apparatuses can be established via a number of auxiliary installations (not shown). In some configurations, the assembly comprises at least two rotary apparatuses connected such, as to mirror each other, whereby said at least two apparatuses are at least functionally connected via their central (rotor) shafts. Such mirrored configuration can be further defined as having the at least two rotary apparatuses 100 mechanically connected in series (in a sequence), whereas functional connection can be viewed as connection in parallel (in arrays). In some instances, the aforesaid “mirrored” arrangement can be further modified to comprise at least two inlets and a common exhaust (discharge) module placed essentially in the center of the arrangement.

By means of said booster heating (thermal or chemical), the temperature of the stream of fluidic medium already preheated to a temperature essentially equal to or exceeding about 1700° C., can be further raised up to 2500° C. and beyond. Provision of additional “booster” units thus allows for increasing the fluid temperature beyond a level generally enabled in a single rotary apparatus 100. In the booster apparatus(es), further heating of the fluid can be achieved by burning fuel gas and air/oxygen or by injecting reactive gas into fluid (to increase fluid temperature through exothermic reactions).

In chemical booster heating 103, fuel gas can be injected through burners with air (or enriched oxygen) to rise temperature of gases. If heated gas contains flammable gases and it is possible to consume these gases for heating only air/or oxygen can be added. Process gases can contain H₂, NH₃, CO, fuel gases (methane, propane, etc.) which may be burned to generate heat. Other reactive gases can be injected to generate heat if feasible.

The rotary apparatuses (100A, 100B, 103, rf. FIG. 2B) can be assembled on the same (rotor) shaft. Each rotary apparatus can be optionally provided with a separate drive (a motor) which allows independent optimization of the apparatuses. When two or more separate rotary apparatuses are used, construction costs (materials etc.) can be optimized in view of operation temperature and pressure.

Additionally or alternatively, at least one rotary apparatus within the assembly can be designed to increase pressure of the fluidic stream. Hence, the at least one rotary apparatus in the assembly can be assigned with a combined heater and blower functionality.

Additionally or alternatively, a stream containing reactive or inert gases (such as stream 8 of FIG. 1) can be fed to the rotary apparatus 100 (not shown) or to any equipment downstream of said apparatus (e.g. into the heat-consuming process section 101). Thus, the reactive gases (such as stream 8 of FIG. 1) may be injected directly to the heat-consuming process unit 101, if the latter is configured to receive such chemicals.

FIG. 2C illustrates the use of the rotary heater apparatuses 100, such as the primary rotary heater apparatus 100A and optionally the additional rotary heater apparatus 100B in indirect process heating. The rotary apparatus 100 (100A, 100B) can be used for indirect heating of fluids in the heat-consuming unit 101, wherein heat is transferred between two non-mixing fluids as in heat exchanger-type configurations. Hence, fluids, such as gases or liquids, can be evaporated (vaporized) or superheated in a feasible heat exchanger arrangement 101 against fluid heated in the rotary apparatus 100. The heat-consuming unit 101 configured to accommodate a heat-consuming process can be represented with any (existing) fired heater, reactor or furnace, or any conventional heat exchanger device. Type of said “heat exchanger” configuration (101) can be selected as needed for optimal heat transfer. Heating gas (see streams 1-3) acting herewith as a heat transfer medium can be selected to be the most suitable for heating and safety (for example: steam, N₂, air). Gas heated in the rotary apparatus 100A, 100B can be close to atmospheric pressure or its pressure can be raised to improve heat transfer. Heat transfer medium 3 heated in the apparatus 100 (rf. stream 3 exiting 100B) is directed to the heat-consuming process 101, where heat is transferred from the stream 3 to a “cold” process stream 6 to produce a “hot” process stream 7. Stream 4 designates the heat transfer medium outflow, respectively.

Process streams 6 and 7 of FIG. 2C thus correspond to streams 9 and 10 of FIG. 1, respectively (indirect heating configuration); while heat transfer medium streams 3 and 4 of FIG. 2C correspond to streams 3 (optionally 4) and 5 of FIG. 1, respectively (indirect heating configuration).

Another exemplary configuration layout for indirect heating of process fluids with the rotary apparatus 100 is presented on FIG. 2F. The heat-consuming unit 101 is set to act as a heat exchanger designed to heat the process stream 6 inflow to a predetermined temperature by means of a stream of a heating medium 3 (heat transfer medium) supplied from the rotary apparatus 100. Heated (“hot”) process fluid stream 7 is thus produced. Heat transfer medium exits, at stream 4, the heat-consuming unit 101 to be recycled back to the apparatus 100. Configuration of FIG. 2F may be applied to heating of gaseous media, such as hydrogen (gas) and/or a hydrogen-containing gas stream, in a heat exchanger 101 within the production facility. Same layout may be applied to raise the temperature of any other process stream flowing through the heat exchanger device.

Although heating of gaseous media can be implemented in the rotary apparatus 100 by simply using steam as a heating fluid (not shown), in cases where the pressure of a gaseous process fluid stream is elevated to above 10 bar (1 MPa), for example, or where the temperature of said gaseous process fluid stream becomes very high, for example up to above 1000° C., it is beneficial to apply the indirect heating concept shown on FIG. 2F. Designing the rotary apparatus 100 to operate at high pressures and/or at high temperatures increases its material requirements and may complicate its technical solutions, which increase the cost of the apparatus. However, designing the apparatus for a low-pressure heating of inert gases such as air, nitrogen, carbon dioxide or steam and using the heated gas to heat hydrogen or other process stream in the process unit 101 (in a heat exchanger configuration) can result in a lower overall cost of the heating system.

In FIG. 2F, the rotary apparatus 100 is used to heat non-working fluids (e.g. inert fluids), such as air, (water) steam, carbon dioxide or nitrogen gas (N₂), at low pressure, such as for example, at pressure below 10 bar (1 MPa). Such non-working fluid is referred to as a “heat transfer medium”. Inflow stream 4 entering the apparatus 100 (heat transfer medium, cold) has a temperature of about 200-1100° C.; and outflow stream 3 exiting 100 (heat transfer medium, hot) has a temperature of about 800-1200° C., respectively. In turn, the temperature of “cold” process fluid 6 (for example, hydrogen) entering the heat-consuming unit 101 is about 20-500° C., while the temperature of “hot” process fluid outflow 7 exiting 101 is about 700-1000° C. In order to allow heat transfer from the heat transfer fluid into the process steam, the temperature of the heated fluid discharged from the rotary apparatus 100 must exceed the target temperature of the heated process fluid.

“Hot” heat-transfer fluid 3 discharged from the rotary apparatus 100 is led into the heat-consuming unit 101 provided, in the layout of FIG. 2F, as a heat exchanger that allows transfer of thermal energy from the heat transfer medium (inert fluid heated in 100) to the process fluid through a heat transfer surface, resulting in heating the hydrogen stream. As the heat transfer medium donates its heat to the process stream, it cools down. Cooled heat transfer medium 4 can be reintroduced into the rotary heater 100 to improve thermal efficiency of the system.

The heat exchanger 101 materials are selected to withstand high temperature hydrogen atmosphere, and/or elevated pressures; however, for stationary equipment like heat exchangers this is still more cost-efficient option than for the rotary apparatus 100.

Using the rotary apparatus 100 allows for optimization of temperature difference in heat exchanger configurations (represented hereby by the heat-consuming units 101), whereby the size of the unit 101 (configured as a heat exchanger, a reactor, a furnace, a heater, etc.) and possible unwanted reactions (fouling, coking) occurring on its surfaces due too high surface temperature can be minimized. High surface temperatures may cause excess fouling in process heaters. Indirect heating as shown on FIG. 2F can be used for example to replace conventional process heaters in various industrial applications.

FIG. 2D illustrates the rotary heater apparatus 100A with a preheater 102 and with a recycle process fluid (stream 4) recycled from a heat consuming process (not shown). Preheater 102 can be electric, fired, combustion engine, gas turbine, etc., or it can be a heat exchanger for recovering excess heat from any high-temperature flow in the process. Provision of the preheater 102 is optional. The concept can further include an optional booster heater 100B downstream of the apparatus 100A. Thermal or chemical booster heating may be utilized. Stream 1′ designates a (feed) fluid sent to the preheater 102. Said fluid is further propagated through the rotary apparatuses 100A, 100B, where the feed is heated and sent to the heat-consuming process at stream 3.

Any one of the rotary apparatuses 100A, 100B can be equipped with a fluid recycle arrangement (see stream 4, FIGS. 2D, 2F). Any combination of the rotary apparatuses with the fluid recycle arrangement can be conceived. Recycling is made possible through recirculation of streams of fluidic medium by the at least one rotary apparatus.

In some configurations, the rotary apparatus 100 can utilize flue gases with low oxygen content exhausted from a conventional fired heater. In such an event, hot flue gases exhausted from the fired heater are mixed with recycle gases (stream 4, FIG. 2D) to be used for heating in the rotary heater 100, 100A. Oxygen content in the flue gases used in described case is preferably below a flammability limit to provide safe heating. Flue gases typically include CO₂, CO, H₂O, SO₂, NOₓ, and any combination thereof.

The method according to the aspect is applicable, fully or partly, to a variety of heat-consuming processes 101, as will be elucidated herein below based on the following embodiments and a number of non-limiting examples.

In embodiments, the method comprises operating the at least one rotary apparatus 100 operatively connected to at least one calciner within the titanium oxide production facility (1000, FIG. 3). In an embodiment, the at least one calciner is configured for titanium oxide making. In an embodiment, the calciner is configured to react titanium hydroxide to form titanium oxide in the titanium oxide (pigment) production facility.

In some configurations, the at least one rotary apparatus 100 can be operatively connected to at least one reactor configured for a chlorination process by which ilmenite is chlorinated to form titanium chloride (FIG. 4). In some configurations, the at least one rotary apparatus is operatively connected to at least one reactor configured for oxidation of titanium chloride to form titanium oxide.

Titanium oxide, which has the formula TiO₂, is most commonly made in one of two production pathways: a sulfate process by which titanium hydroxide (TiOH) is calcinated in a calciner to produce titanium oxide, or a chloride process by which ilmenite (FeTiO₃) is first chlorinated in the presence of chlorine and coke (i.e. carbon) to form titanium chloride (TiCl₄) and then oxidized in the presence of oxygen and optionally toluene to form titanium oxide.

In the sulfate-based process for forming titanium oxide, depicted schematically in FIG. 3, sulfuric acid is used to digest ilmenite, a titanium-iron oxide mineral having general formula of FeTiO₃, so that it may be reduced, clarified, crystallized, and dissolved in a titanium oxysulfate (TiOSO₄) solution. Digestion of ilmenite typically proceeds at about 100° C. Sulfuric acid is also used to digest titanium slag so that it can be clarified and dissolved in a TiOSO₄ solution. These solutions are combined and subjected to hydrolysis (initiated at about 110° C.) to form titanium hydroxide, which is filtered before being calcinated. The calcination step involves heating titanium hydroxide to temperatures of up to 1100° C., but normally between about 300° C. and 900° C., resulting in the evaporation of water and crystallization of TiO₂. In the facility 1000, the rotary apparatus is operatively connected to the at least one calciner (“Calcination”, FIG. 3). Additionally, the apparatus 100 can be further operatively connected to a digestor and/or a hydrolysis reactor or furnace, as designated on FIG. 3 with broken line arrows. By utilizing a rotary apparatus as described herein, the temperatures necessary to enable calcination of titanium hydroxide in the sulfate-based titanium oxide production process may be reached efficiently and with significantly reduced greenhouse gas emissions.

The calciner for reacting titanium hydroxide to form titanium oxide thus represents a heat-consuming unit/utility 101. The digester and/or the hydrolysis reactor or furnace, to which the rotary apparatus 100 is operatively connected, as shown on FIG. 3, may also represent the heat-consuming utilities 101, within the concept of the present invention.

Furthermore, the use of a rotary apparatus as described herein can enable tuning of the calcination temperature, which in turn can enable the formation of titanium oxide having different crystal structures and properties.

In the chloride-based process for forming titanium oxide within related production facility 1000, depicted schematically in FIG. 4, ilmenite ore or another TiO₂ containing raw material, such as natural or synthetic rutile, and coke (carbon) are chlorinated in the presence of oxygen and chlorine to form titanium chloride. The process of FIG. 4 is advantageously applicable to raw materials that contain at least 68% of titanium oxide. This step of the process (box “Chlorination”) is a carbothermic reaction that utilizes coke as a reducing agent at temperatures of several hundred degrees Celsius (900-1000° C.).

Exemplary chlorination of ilmenite in presence of coke proceeds as follows:

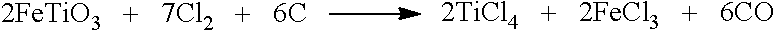

After forming titanium chloride, it is purified and oxidized in the presence of oxygen to produce titanium oxide and gaseous chlorine, which is recycled to the chlorination step, as shown on FIG. 4. The oxidation step involves heating oxygen to around 1200° C. and separately heating the titanium chloride to around 800° C. before introducing the titanium chloride into the oxidation reactor.

Hence, in an embodiment, a method for titanium oxide production is provided and comprises, connecting, in the titanium oxide production facility, the at least one rotary apparatus 100 to at least one reactor or furnace configured to react ilmenite and coke in the presence of oxygen and chlorine to produce titanium chloride. Any reactor device adapted for production of titanium oxide may be utilized, such as a fluidized bed reactor, for example.

In embodiment, the at least one rotary apparatus is further connected to a second reactor or furnace configured to react titanium chloride in the presence of oxygen and optionally toluene to produce titanium oxide (box “Oxidation”, FIG. 4). In embodiments, the method comprises (super) heating titanium chloride (TiCl₄) using the rotary apparatus to 500-1000° C. before the actual conversion reactor. Oxygen (O₂) can be (super) heated to essentially >1000° C. using a parallel rotary apparatus prior to being contacted with titanium chloride in the conversion reactor. Heating by the rotary apparatus can be direct (process fluid is heated in the rotary apparatus) or indirect (fluid heated in the rotary apparatus is a heat transfer fluid which further transfers its heat to the process fluid in a contactless manner).

Each of the reactor for chlorinating ilmenite to form titanium chloride and the reactor for oxidizing titanium chloride to form titanium oxide represents a separate heat-consuming unit/utility 101, as shown on FIG. 4.

The following temperatures are involved at different steps of the chloride-based process:
Chlorination reaction temperature: 700-1200° C.;
Oxidation reaction temperature: 900-1400° C.;
TiCl₄ superheating before oxidation reactor: 500-1000° C.;
Oxygen superheating before oxidation reaction: above 1000° C., up to 1700° C.

Oxygen superheating may be done by feeding in a limited amount of carbon monoxide or other fuel, so that part of the oxygen burns and thus it is possible to reach extra high temperatures for superheating oxygen.

It is noted that in conventional processes, heating of titanium chloride is performed indirectly in furnace-type heaters, while conventional process of oxygen heating is performed with plasma flame by burning a part of the oxygen with carbon monoxide or other fuel. By using the rotary apparatus, the actual conversion reactor can be heated also indirectly.

In embodiments, titanium chloride is reacted, in the actual conversion reactor, in the presence of oxygen and toluene to produce titanium oxide.

One or more rotary apparatuses as described herein may be used to enable the carbothermic reaction, the preheating of oxygen, the preheating of titanium chloride, or a combination thereof.

Rotary apparatus 100 mediated calcination process described hereinabove can be applied for production of other metal oxides, such as for example, iron (II) oxide (FeO), lead (II) oxide (PbO), zinc (II) oxide (ZnO), copper (II) oxide (CuO), and magnesium (II) oxide (MgO), from related carbonites, namely, iron (II) carbonate (FeCO₃), lead (II) carbonate (PbCO₃), zinc (II) carbonate (ZnCO₃), copper (II) carbonate (CuCO₃), and magnesium (II) carbonate (MgCO₃), respectively, as well as their mixtures and/or hydrated forms.

In some configurations, the at least one rotary apparatus 100 can be operatively connected to at least one furnace configured to melt ore such as inorganic volcanic rock, basalt, and/or dolomite in a stone- or mineral-wool production process and a related facility 1000. Stone- or mineral-wool, referred to herein as simply “mineral-wool” for brevity, is an insulation material that involves melting minerals in the presence of a thermosetting resin binder (usually in a ratio of 98% mineral and 2% binder) at temperatures of around 1300° C. to 1500° C., as depicted schematically in FIG. 5. After melting into what is referred to as a “melt,” the material is spun into fibers (see “Spinning” box, FIG. 5). The fibers are drawn from spinning wheels with a stream of pressurized air blown into the spinning chamber. A binder is added before the fibers are cooled and hardened in a curing oven at around 200° C. using hot air typically supplied from after-burner(s). Within the concept of the present invention, the after-burner(s) can be replaced with the rotary apparatus 100 (not shown). After leaving the curing oven, the wool is conveyed through a cooling section, to be cooled by ambient air from a production hall, and proceeds to cutting to the required size and shape, followed with packing. Exhaust gas(-es) from spinning, curing and cooling processes are directed to filters and/or other environmental barriers before the emissions will leave the production facility. Wool waste originating from the process and other recyclable wool material can be mixed with the raw material and recycled.

The furnace for melting minerals to form a melt configured to be spun into fibers for forming mineral-wool represents herewith the heat-consuming unit/utility 101. The furnace 101 used to melt the minerals may be in the form of a cupola furnace, which is commonly used for mineral-wool production. Mineral-wool is also sometimes produced using electric-arc furnaces or gas-fired furnaces. However, by using a furnace 101 heated using one or more rotary apparatuses 100 as described herein, the raw materials may be melted as part of a mineral-wool production process without the burning of fossil fuels.

Hence, in an embodiment, a method for mineral or stone wool production is provided and comprises generation of a heated fluidic medium by at least one rotary apparatus integrated into a mineral wool production facility, the heated fluidic medium being configured to supply heat to a melting process for melting raw materials such as inorganic volcanic rock or slag form a melt that is spun into fibers and formed into wool. In embodiments, the method comprises supplying the heated fluidic medium generated by the rotary apparatus 100 to a furnace 101 configured to melt raw minerals for spinning and binding into mineral-wool, and/or to a curing oven.

Overall, in said mineral or stone wool production facility, the at least one rotary apparatus 100 can be operatively connected to at least one heat-consuming unit 101 provided as any one of: (i) a furnace, a kiln or a reactor configured for making mineral wool, (ii) a furnace configured to melt raw materials into a melt for spinning into fibers, or (iii) any combination thereof.

The invention further concerns a method and a facility for manufacturing gypsum using the rotary apparatus(-es) 100. In some configurations, the at least one rotary apparatus can be operatively connected to at least one calciner configured to calcinate crushed gypsum (CaSO₄) powder. Crushed gypsum is used in forming plaster or stucco by first crushing natural gypsum ore into small particles, then grinding the particles into a powder. This powder is calcinated to drive off water, resulting in a dehydrated gypsum powder suitable for use as plaster or stucco. The calcination process takes place at temperatures of around a few hundred degrees Celsius. By using a furnace or calcination reactor heated by the rotary apparatus 100 as described herein, the gypsum manufacturing process may be more efficient and consume less nonrenewable resources.

Integration of at least one rotary apparatus 100 into a gypsum production process and a related facility 1000 is schematically illustrated on FIG. 8A. Gypsum (CaSO₄) calciner operates at about 600-700° C. The raw material (hereby, crushed gypsum powder) is first washed, pH is controlled, then it is dried/water content is reduced before the calcination process, typically conducted in a rotating kiln. Drying the gypsum powder before calcination ensures a more efficient and uniform calcination process, resulting in higher quality gypsum products.

With heat, provided by means of inert gas like air, nitrogen or other, calcination (dehydration) of gypsum (2CaSO₄·2H₂O, calcium sulfate dehydrate) produces partially or totally dehydrated calcined gypsum, i.e. hemihydrate ((CaSO₄)₂·H₂O) or anhydrites (with no water), in temperature ranges from 40° C. or 200° C. to 1180° C. or even above, according the equation below:

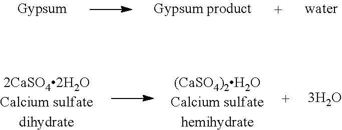

Gypsum production is typically performed in directly fired rotary kilns or in indirectly heated kettles (upright or horizontal). The rotary apparatus can be connected to any one of these devices. Prior to calcination, the gypsum powder may be (pre)heated, in order to reduce the amount of energy required during the calcination process by removing some of the moisture content from the gypsum powder beforehand. This may result in faster and more efficient calcination. (Pre) heating and calcination processes may be conducted in the same kiln device; therefore, on FIG. 8A these processes (and related equipment) are collectively designated with reference numeral 101. Still, these processes may be conducted in separate kilns or furnaces. Any one of these kilns or furnaces may hence represent the heat-consuming utility 101. Heated medium produced in the rotary apparatus 100 can further be used for drying of gypsum powder, if required by the process. A part of the inert gas used for (pre) heating can be withdrawn from the process and recycled.

FIG. 8B schematically illustrates a process of gypsum production using a dry sorbent injection (DSI) technology, commonly employed in desulfurization of flue gases. In the DSI process, reduction of sulfur dioxide (SO₂) occurs through injecting dry calcium-based sorbent materials into a furnace. Suitable calcium-based sorbents include for example limestone (CaCO₃), hydrated lime (Ca(OH)₂), and quick lime (CaO). Sorbent activation occurs as the particles are heated forming porous particles with large surface area. This process takes place in the furnace through particle calcination. For example, during calcination of calcium carbonate (CaCO₃), reactive calcium oxide (CaO) is formed, while carbon dioxide and water are driven away from the sorbent crystal structure. Calcination is an endothermic reaction and in present case it proceeds at a temperature range of about 800-1200° C. Calcium oxide undergoes, in turn, a process of sulfation or sulfur capture by reacting with sulfur dioxide gas according to the following equation:

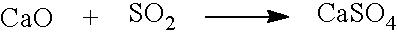

whereupon calcium sulfate (CaSO₄) is formed as a gypsum product. Sulfation rates are controlled by adjusting a diffusion rate of SO₂ through porous sorbent particles. Sulfation reaction proceeds at high temperatures (typically above about 870° C.). Below about 870° C., reaction rates are low and removal of SO₂ is inefficient.

Another phenomenon, which also occurs at these temperatures, is deactivation of the CaO via thermal sintering (not shown). At mentioned temperature ranges (800-1200° C.), calcination, sulfation and sintering of the sorbent proceed essentially concomitantly. Calcination, sulfation and sintering thus take place in the same furnace, which may be configured as a horizontally fired or a vertically fired unit. Therefore, these processes are collectively designated on FIG. 8B with reference numeral 101. The furnace accommodating these processes hence represents the heat-consuming unit/utility 101, accordingly. A part of the inert gas used for (pre) heating can be withdrawn from the process and recycled.

Fluids heated using the rotary apparatus 100 can be any one of: flue gases (e.g. SO₂), recycled gas and their components as well as air, oxygen, and nitrogen. To increase efficiency of the DSI process, two rotary apparatuses 100 may be utilized—to heat the inert gas (air, N₂) used as a heating medium in calcination, and to heat SO₂ used as a reactant in the sulfation reaction. However, at high temperatures employed by the DSI process, mixing oxygen gas with SO₂ is undesirable, because in presence of excess oxygen, at about 800° C., the SO₂ further oxidizes into sulfur trioxide (SO₃). The latter forms a liquid aerosol known as sulfuric acid (H₂SO₄) mist that is very difficult to remove.

The invention further concerns a method for wood pulp production, such as in wood pulp and paper production, in which method the at least one rotary apparatus in integrated into a wood pulp production facility and is configured to supply the heated fluidic medium into said wood pulp production facility. In some configurations, the at least one rotary apparatus can be operatively connected to at least one heat consuming process associated with the Kraft process for wood pulp production. The Kraft process and a related facility 1000, depicted schematically in FIG. 6, is used to convert wood chips into pulp through a series of steps including steaming, digestion, impregnation with liquors, cooking, recovery, blowing, screening, washing, and bleaching. The Kraft process uses sodium hydroxide (NaOH) and sodium sulfide (Na₂S) to pulp wood feedstocks. An aqueous solution of sodium sulfide and sodium hydroxide is referred to as a white liquor and is used to cook woodchips in a digester to yield fiber and a liquid stream called a black liquor. The usable fiber (pulp) is sent for further storage or bleaching. The black liquor is separated from the fiber pulp by washing and concentrated in multi-effect evaporators to a point where it can be effectively boiled in a recovery boiler, in an oxygen-deficient environment, to form Na₂S. Sodium and sulfur are recovered as a molten smelt which consists mostly of Na₂S and sodium carbonate (Na₂CO₃). The molten smelt enters a smelt dissolving tank, where it dissolves in water to form a green liquor (an aqueous solution of sodium carbonate and sodium sulfide). Biogenic CO₂ is produced. The green liquor is sent, through a clarifier, to causticizer, where it is reacted with calcium oxide (CaO), to convert the Na₂CO₃ (present in the form of Na₂CO₃·(H₂O)ₓ) to NaOH and to produce calcium carbonate (CaCO₃). The Na₂S passes through the causticizing step unchanged (not shown). The causticizer typically incorporate slaker(s) with cyclones and scrubbers to minimize dusting. The causticized green liquor forms the white liquor containing mostly NaOH and Na₂S, which is returned to the digestion step. Calcium carbonate precipitated from the causticizing step (in a white liquor clarifier) is washed, filtered and sent to a lime kiln.

The cooking process, in particular, is typically performed in a lime kiln at temperatures between about 800° C. to 1100° C. The lime kiln is characterized by the heating of calcium carbonate CaCO₃ to form calcium oxide CaO and carbon dioxide CO₂. The CaO is used during the recovery process by which the causticizer is used to recover sodium hydroxide, which is in turn used in the digestion step. Carbon dioxide produced by the lime kiln is biogenic, therefore, it can be reacted with hydrogen gas (H₂), as shown on FIG. 6, and potentially used for production of green methanol (MeOH). By heating the lime kiln with a rotary apparatus 100 (100-4) as described herein, the overall energy and fuel demand of the Kraft process may be made more efficient. The lime kiln for reacting calcium carbonate to form carbon dioxide and calcium oxide in the Kraft process is thus designated with the reference numeral 101 as representing the heat-consuming unit/utility 101.

Integration of the rotary apparatus 100 in the exemplary Kraft process is shown on FIG. 6. In addition to operatively connecting the rotary apparatus 100 (100-4) to the lime kiln 101 configured to perform the cooking process, the rotary apparatus(-es) can be employed in a number of processes preceding cooking. For example, the rotary apparatus 100 can be operatively connected to any one of the digester (see 100-1), the recovery boiler (see 100-2), and the causticizer including the white liquor clarifier (see 100-3). Any one of these units/utilities may therefore represent the heat-consuming units/utilities 101, within the concept of the present invention.

In some configurations, the at least one rotary apparatus can be operatively connected to at least one Yankee Hood associated with a tissue mill process in a related facility 1000, depicted schematically in FIG. 7. The process includes pulping (i), whereby woodchips are cooked in a mixture of chemicals, and a resulted mass is reduced to cellulose fibers, lignin and other substances. The usable fiber (pulp) proceeds to refining (ii), where pulp and washed and bleached, and different pulp stock types are mixed depending in the output requirements. Refined fiber proceeds to a paper web forming step (iii), by being received in a headbox section of a tissue machine, where the fiber is sprayed onto screens of mesh to drain the water, and is further passed to a press section to remove the water from a paper web. A paper stock is further sent to a Yankee Hood drying process (iv), where the paper undergoes drying in the area between a suction press roll and a Yankee (a drying cylinder) reaching about 45% of dryness. The Yankee cylinder is heated up with steam under pressure and the paper web attaches to the hot surface of the drying cylinder, letting the water evaporate through the paper web. At the same time heated air is blown onto the paper web by dryers (hoods). The drying process is thus implemented through a combined action of hot air blown onto the paper web by dryers (hoods) and the pressurized steam inside the Yankee. In tissue paper manufacturing, the tissue paper is heated in a suction press roll to dry the tissue paper while ensuring the tissue paper retains its surface area. The Yankee Hood drying process takes place at temperatures of around 400° C. to 600° C. The paper with about 5% of moisture is separated from the Yankee by creping blades (v), thereafter the paper is rolled into rolls for transportation and storage. The processes of paper web forming (iii), Yankee drying (iv), creping and winding (v) typically proceed in a tissue machine.

In embodiment, the rotary apparatus 100 can be integrated into the tissue mill process by operatively connecting the rotary apparatus 100 with the Yankee drying process and the related Yankee Hood device (FIG. 7, step iv). The rotary apparatus 100 may replace the hood dryers by generating heated air and/or used to heat the Yankee drying cylinder. By heating the Yankee Hood with a rotary apparatus as described herein, the tissue mill process may be made more efficient. The Yankee Hood for dehydrating tissue paper thus represents the heat-consuming unit/utility 101, within the concept of the present invention.

The invention further concerns a method for producing cathode and/or anode material(s). The method comprises generation of a heated fluidic medium by at least one rotary apparatus integrated into a battery manufacturing process and related facility, wherein the heated fluidic medium is configured to supply heat to a kiln and burner used in the production of cobalt, nickel, manganese, and/or graphite.

In some configurations, the at least one rotary apparatus 100 can be operatively connected to a kiln or burner associated with a battery manufacturing process. Batteries include processed metals as cathodes and anodes, with materials such as cobalt, nickel, and manganese often used as cathodes and graphite often used as anodes. These processes involve calcination, sintering, oxidation, or the like, taking place at high to extremely high temperatures. For example, calcination and sintering involve exposing the cathode and/or anode powders to temperatures ranges between 700-1000° C., in order to remove any remaining water or a binder from a preceding drying process, and to fuse the metals tightly together. Typical furnaces used for calcination and sintering in battery manufacturing processes are roller hearth kilns, rotary kilns and pusher kilns. By heating the heat consuming processes with a rotary apparatus as described herein, the battery manufacturing process may be made more efficient.

Integration of the rotary apparatus(-es) 100 into the processes of battery manufacturing involving the processes of cathode (active) materials and anode (active) materials production in related facilities 1000 is schematically illustrated on FIGS. 9A, 9B (cathode) and FIG. 9C (anode).

Cathode active materials (CAM) are typically composed of metal oxides. The most common cathode materials used in lithium-ion batteries include lithium cobalt oxide (LiCoO₂), lithium manganese oxide (LiMn₂O₄), lithium iron phosphate (LiFePO₄ or LFP), and lithium nickel manganese cobalt oxide (LiNiₓCo_{y}Mn₂O₂ or NCM). Each of these materials offers varying levels of energy density, thermal stability, and cost-effectiveness.

Anode active materials (AAM), on the other hand, are generally made from carbon-based materials, such as graphite, from silicon, or a combination of both. Graphite is the most commonly used anode material due to its high electrical conductivity, chemical and structural stability, mechanical strength, and low cost.

Despite a wide variety of commercial processes available for manufacturing of anodes and cathodes, these processes typically have the following steps in common. One of these common steps includes formation of the electrode. Electrodes are formed from mixtures of compounds referred to as CAMs and AAMs to form cathodes and anodes, respectively. These synthesized materials are then ground into a fine powder and mixed with binders and solvents to create a slurry ready for further processing. These slurry mixtures are then coated onto a metal foil. which is typically an aluminum foil for the anode and a copper foil for the cathode, and dried in an oven to secure the material on the foil and remove remaining solvents. After drying, the coated foils undergo a calendering process, where they are passed through a series of rollers to compress and smooth the coating, thereby ensuring uniform thickness and proper adhesion.

Resulting coated anode and cathode foils are then ready to be cut to size and combined with other components to build a lithium-ion battery cell.

Exemplary processes of producing LiNiₓCo_{y}Mn₂O₂ (NCM) cathode materials are schematically illustrated on FIGS. 9A and 9B. The cathode material obtained as shown on FIG. 9A also includes tin (Sn). In the process of FIG. 9A, a synthesized dried precursor (Ni_{0.82}Co_{0.12}Mn_{0.06}(OH)₂) was mixed with a tin (II) ethoxide in isopropyl alcohol at 60° C. Sn-incorporated precursor was mixed with the stoichiometric lithium source, herein, LiOH (Li/Me=1.02) and calcinated at 800° C. for 24 hours in O₂ atmosphere to obtain cathode active materials Li[Ni_{0.82}Co_{0.12}Mn_{0.06}]₁₋ₓSnₓO₂ (x=0.004, 0.008, 0.012, 0.024).

The rotary apparatus(-es) 100 can be incorporated to the above described process to supply the heated fluidic medium during mixing the precursor powder with lithium source and/or during calcination. Heating of the cathode precursor powder during mixing is preferably implemented with inert gases, such as air or nitrogen gas (see 100-1). In calcination step, the rotary apparatus 100 (100-2) can be used for (indirect) heating of the calcination furnace instead of a fossil-fuel fired burner, or to supply a heated oxygen-containing fluidic medium (air or O₂) into the furnace. In some instances, the rotary apparatus 100 (100-2) can be used to introduce hot oxygen to the calciner. Gases utilized as heating media can be withdrawn from the process (dashed arrow) and/or recycled (not shown). The calcination furnace hence represent the heat-consuming unit/utility 101.

The calcination temperature plays a significant role in the structural and functional (e.g. energy-storage) performance of metal oxide nanomaterials in Li-ion battery applications. By varying calcination temperature range within 800-1000° C., the cathode materials microstructures can be affected, and electrochemical performance of resulting electrodes can be adjusted. Precise temperature control throughout the process is hence critical, as it influences electrochemical performance of the final product and results in a more optimal active material. Operatively connecting the rotary apparatus 100 to the calcination furnace allows for controlling calcination temperature with high precision, in particular, when the temperature needs to be adjusted during the process. By way of example, some NCM cathode materials undergo calcination at lower temperatures (e.g. 500° C.) for several hours; thereafter the temperature in the furnace has to be raised to 800-1000° C. (not shown). The rotary apparatus 100 allows for temperature adjustment in the heat-consuming unit 101, herein, a calcinator or other reactor for forming cathode and/or anode materials, with high precision control, in a short-period of time.

FIG. 9B shows an exemplary way of incorporating the rotary apparatus 100 into a process of recycling cathodic materials from Li-ion batteries typically used in cell phones. Incorporating recycled content in the production of cathode and anode materials is a vital step towards achieving electrification and clean energy goals on a global scale. Reusing valuable materials from end-of-life batteries and manufacturing scraps, enables conservation of natural resources, reduction of waste, and minimizing the environmental impact of mining and processing raw materials. Incorporating sustainable practices in battery manufacturing can lead to a greener, more efficient energy storage industry, ultimately supporting the transition to renewable energy sources and electric transportation.

In the process of FIG. 9B, recycled cathodic materials from Li-ion batteries were used to produce a Li/Co ferrite composite. In the process, used Li-ion batteries were shredded and thermally treated at 150-500° C. for a short time period (1-2 hours) to separate the cathode active material (LiCoO₂) including a residual carbon powder from the aluminium foil. Then, iron (III) oxide (Fe₂O₃) was added to CAM, and the resulting mixture was fired in a furnace (representing herein the heat-consuming unit 101) at a temperature range between 900-1100° C. for several hours (1-10 hours), whereupon a lithium-cobalt ferrite composite was obtained.

Incorporation of the rotary apparatus 100 to this process at a high-temperature firing step (by operatively connecting the apparatus 100 to the firing furnace to supply the heated fluidic medium to heat the furnace) may improve efficiency of the process and make the recycling process more sustainable in view of electrification. Any suitable media, such as inert gas (air, N₂) may be used as a heating fluid.

Production of anode materials using the rotary apparatus(-es) 100 is described with reference to FIG. 9C. As mentioned above, the most commonly used anode materials are carbon-based, with graphite being predominant among them. Synthetic (also referred to as moulded) graphite is a carbon material that has been treated at temperatures above 2700° C.

Synthetic graphite is traditionally manufactured from a carbon-based filler, such as coke, recycled graphite, natural graphite, and carbon black. The raw filler material is calcinated in a calcination furnace at about 1200-1300° C., crushed and sieved to get a specific distribution of particle size. These particles are bound together using a binder (coal-tar pitch or petroleum pitch), and the mixture is formed (moulded) into shape (FIG. 9C). Forming techniques include for example extrusion, compression and isostatic pressing. Selection of the forming technique may influence the properties of a final product (graphite).

The binder in these shapes undergoes baking upon heating the shapes to up to 1200° C. in an inert atmosphere (the process known as carbonization), and an extensive pore network is created. To achieve required porosity and quality the product is impregnated with the same binder material (e.g. the coal-tar pitch) or polymers in a high-pressure autoclave. Impregnation and baking (carbonization) are repeated until a require density and/or other properties are reached. Finally the carbon material is converted to a graphitic structure in a graphitization furnace at temperatures up to 3000° C. by passing a current through a conducting coke bed surrounding the product. Graphitization furnace is typically a resistance or induction furnace.

Cooling the newly made graphite typically may cause microcracking (known as Mrozowski cracks). These cracks and a network of pores occupy about 20% of a total volume of the graphite product. The porous structure can greatly increase the number of sites for lithium-ion intercalation-deintercalation in a graphite lattice and facilitate the diffusion of lithium ions therein. Therefore, the porous graphite demonstrates an improved high-rate cycling stability as anode materials for Li-ion batteries. Additionally The porous structure plays an important role in the behaviour of graphite under irradiation (so-called nuclear graphite).

The at least one rotary apparatus 100 can be advantageously integrated into the graphite manufacturing facility 1000 of FIG. 9C by being operatively connected to any one of a calcination furnace (see apparatus 100), a carbonization furnace (see apparatus 100-1), or both. The rotary apparatuses 100, 100-1 can be configured to heat inert gases, such as air or nitrogen gas, for example, to be used as a heating media in related furnaces. Inert gases heated by the rotary apparatus and blown into the furnace can be used to create an inert atmosphere needed at a particular process step. Additionally or alternatively, the rotary apparatus 100 (see apparatus 100-2) can be utilized to indirectly heat the carbonization furnace to replace natural gas fuel burner(s), for example. Any suitable heating medium can be used for this purpose. Electrification of the rotary apparatus(-es) 100 enables signification reduction of emissions (particular matter, SOₓ, NOₓ, etc.) from the graphitisation process. Calcination furnace and carbonization furnace are considered herewith as heat-consuming units 101.

In some instances, one or more rotary apparatus(-es) 100 can be further operatively connected to the graphitization furnace, to supply heat thereto (not shown).

The invention further provides for a method for flash drying of one or more chemicals with a heated fluidic medium generated by at least one rotary apparatus integrated into a chemical production facility 1000. In some configurations, the at least one rotary apparatus 100 can be operatively connected to a dryer 101 associated with a chemical production process (FIG. 10). Some chemicals that come in the form of powder or other granular material must be flash dried to ensure the chemical has no residual moisture. Furthermore, some of these chemicals are temperature-sensitive. These chemicals often undergo a flash drying process to drive off moisture without impacting chemical efficacy. By heating the flash dryer with a rotary apparatus as described herein, the chemical manufacturing process may be made more efficient.

Drying is one of the most basic operations in industrial manufacturing facilities, including chemical manufacturing. The principle of flash drying is to evaporate surface moisture instantaneously (during about 0.5 to 3 seconds) as a result of feed exposure to hot air or other gas. Most flash dryers utilizes air as a drying medium. Flash dryers have proved particularly efficient in drying feed materials having moisture content of about 30-40%. Flash drying can be conducted at temperatures within a range of about 150° C. to about 1000° C., or even higher, depending on the requirements of the drying process.

Flash dryers can be used to remove excess moisture from various products, such as slurries, pastes, crushed cakes, powders and granules. Flash dryers operate efficiently at operating power rates ranging from a few kilograms per hour to several hundred tons per hour (depending on the apparent density of the product).

Integration of the at least one rotary apparatus 100 into a chemical production facility that includes a flash-dryer 101 is schematically shown on FIG. 10. FIG. 10 shows a closed-cycle flash drying arrangement; however the rotary apparatus(es) 100 can be integrated to an open-cycle drying arrangement in similar manner. In the flash-dryer of FIG. 10, the rotary apparatus 100 can be used to directly heat the drying medium (e.g. air, nitrogen or other suitable inert gas) inside the rotary apparatus or to serve as a heat exchanger to indirectly heat the drying medium via a process of (indirect) heat transfer. Indirect heating using the apparatus 100 is described hereinabove with reference to FIGS. 2C and 2F. To indirectly heat the drying media (e.g. air), the rotary apparatus can be arranged to superheat steam; thereby the drying medium (air) will be heated via a process of heat transfer between air and the superheated steam.

Drying medium (e.g. air) heated by the apparatus 100 via direct or indirect heating routes is further blown into the dryer 101, in which the feedstock becomes dispersed in a hot air/gas stream and gets thoroughly mixed. Feed material mixed with hot air/gas is conveyed through a drying duct to a cyclone by the pressure created by a blower (not shown). In an event the rotary apparatus 100 is used for direct heating of fluids, provision of separate condenser or heat exchanger device (HEX) may be needed.

The rotary apparatus 100 thus replaces conventional hot air generators and/or steam/thermal fluid based radiators and/or conventional indirect heat exchangers. All these device are typically powered with fossil fuels (e.g. natural gas, diesel, or propane) burned in a combustion chamber. By using electrically powered apparatus(-es) 100, significant reduction of reduction of emissions can be achieved.

It is clear to a person skilled in the art that with the advancement of technology the basic ideas of the present invention may be implemented and combined in various ways. The invention and its embodiments are thus not limited to the examples described herein above, instead they may generally vary within the scope of the appended claims.

1. A method for titanium oxide production, the method comprising generation of a heated fluidic medium by at least one rotary apparatus integrated into a titanium oxide production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting input energy into the at least one rotary apparatus integrated into the titanium oxide production facility, the input energy comprising electrical energy,
supplying the stream of heated fluidic medium generated by the at least one rotary apparatus into the titanium oxide production facility, and
operating said at least one rotary apparatus and said titanium oxide production facility to carry out titanium oxide production at temperatures essentially equal to or exceeding about 500 degrees Celsius (° C.).

2. The method of claim 1, wherein, in the titanium oxide production facility, the at least one rotary apparatus is connected to at least one reactor or furnace configured for titanium oxide making.

3. The method of claim 1, wherein, in the titanium oxide production facility, the at least one rotary apparatus is connected to at least one calciner configured to react titanium hydroxide to produce titanium oxide.

4. The method of claim 1, wherein, in the titanium oxide production facility, the at least one rotary apparatus is connected to at least one reactor or furnace configured to react ilmenite and coke in the presence of oxygen and chlorine to produce titanium chloride.

5. The method of claim 4, wherein the at least one rotary apparatus is further connected to a second reactor or furnace configured to react titanium chloride in the presence of oxygen to produce titanium oxide.

6-28. (canceled)

29. A method for mineral wool production, the method comprising generation of a heated fluidic medium by at least one rotary apparatus integrated into a mineral wool production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting an amount of input energy into the at least one rotary apparatus integrated into the mineral wool production facility, the input energy comprising electrical energy,
supplying the stream of heated fluidic medium generated by the at least one rotary apparatus into the mineral wool production facility, and
operating said at least one rotary apparatus and said mineral wool production facility to carry out mineral wool production at temperatures essentially equal to or exceeding about 500 degrees Celsius (° C.).

30. The method of claim 29, wherein, in the mineral wool production facility, the at least one rotary apparatus is connected to at least one reactor or furnace configured for mineral wool making.

31. The method of claim 29, wherein, in the mineral wool production facility, the at least one rotary apparatus is connected to at least one furnace configured to melt raw material to produce a melt.

32-53. (canceled)

54. A method for gypsum production, the method comprising generation of a heated fluidic medium by at least one rotary apparatus integrated into a gypsum production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting an amount of input energy into the at least one rotary apparatus integrated into the gypsum production facility, the input energy comprising electrical energy,
supplying the stream of heated fluidic medium generated by the at least one rotary apparatus into the gypsum production facility, and
operating said at least one rotary apparatus and said gypsum production facility to carry out titanium oxide production at temperatures essentially equal to or exceeding about 500 degrees Celsius (° C.).

55. The method of claim 54, wherein, in the gypsum production facility, the at least one rotary apparatus is connected to at least one reactor or furnace configured for gypsum making.

56. The method of claim 54, wherein, in the gypsum production facility, the at least one rotary apparatus is connected to at least one boiler configured to dehydrate crushed gypsum ore.

57-76. (canceled)

77. A method for wood pulp production, the method comprising generation of a heated fluidic medium by at least one rotary apparatus integrated into a paper production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting an amount of input energy into the at least one rotary apparatus integrated into the paper production facility, the input energy comprising electrical energy,
supplying the stream of heated fluidic medium generated by the at least one rotary apparatus into the paper production facility, and
operating said at least one rotary apparatus and said paper production facility to carry out titanium oxide production at temperatures essentially equal to or exceeding about 500 degrees Celsius (° C.).

78. The method of claim 77, wherein, in the paper production facility, the at least one rotary apparatus is connected to at least one reactor or furnace configured for paper making.

79. The method of claim 77, wherein, in the paper production facility, the at least one rotary apparatus is connected to at least one lime kiln configured to react calcium carbonate to produce carbon dioxide and calcium oxide as part of a Kraft process.

80. The method of claim 77, wherein, in the paper production facility, the at least one rotary apparatus is connected to at least one Yankee Hood configured to dehydrate tissue paper.

81-102. (canceled)

103. A method for cathode or anode production, the method comprising generation of a heated fluidic medium by at least one rotary apparatus integrated into a battery production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting an amount of input energy into the at least one rotary apparatus integrated into the battery production facility, the input energy comprising electrical energy,
supplying the stream of heated fluidic medium generated by the at least one rotary apparatus into the battery production facility, and
operating said at least one rotary apparatus and said battery production facility to carry out titanium oxide production at temperatures essentially equal to or exceeding about 500 degrees Celsius (° C.),
wherein the at least one rotary apparatus is configured to supply heat to a cathode and/or anode production process.

104. A method for flash drying of one or more chemicals, the method comprising generation of a heated fluidic medium by at least one rotary apparatus integrated into a chemical production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to impart thermal energy to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the method further comprises:
conducting an amount of input energy into the at least one rotary apparatus integrated into the chemical production facility, the input energy comprising electrical energy,
supplying the stream of heated fluidic medium generated by the at least one rotary apparatus into the chemical production facility, and
operating said at least one rotary apparatus and said chemical production facility to carry out flash drying of one or more chemicals at temperatures essentially equal to or exceeding about 500 degrees Celsius (° C.).

105. The method according to claim 1, comprising generation, by the rotary apparatus, of the fluidic medium heated to the temperature essentially equal to or exceeding about 500 degrees Celsius (° C.), preferably, to the temperature essentially equal to or exceeding about 1200° C., still preferably, to the temperature essentially equal to or exceeding about 1700° C.

106-115. (canceled)

116. An industrial production facility comprising at least one rotary apparatus configured to generate a heated fluidic medium and at least one heat-consuming unit configured to carry out a process of processes related to industrial production, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
wherein the rotary apparatus is configured to operate such that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein said at least one rotary apparatus is configured to receive an amount of input energy, the input energy comprising electrical energy, and to generate a heated fluidic medium for inputting thermal energy into at least one heat-consuming unit configured to carry out a process or processes related to material production at temperatures essentially equal to or exceeding about 500 degrees Celsius (° C.),
wherein the industrial production facility is one of (i) a titanium oxide production facility, (ii) a mineral-wool production facility, (iii) a gypsum production facility, (iv) a wood pulp and paper production facility, (v) a cathode/anode production facility, or (vi) a chemical production facility.

117-125. (canceled)

126. A method for inputting thermal energy into a process or processes related to producing a material in a production facility, the method comprises generation of a heated fluidic medium by at least one rotary apparatus integrated into the production facility, the at least one rotary apparatus comprising:
a rotor with a plurality of rotor blades arranged into at least one row around a rotor hub mounted onto a rotor shaft,
a plurality of stationary blades or vanes arranged into an assembly adjacent to the at least one row of rotor blades, and
a casing with a duct formed between at least one inlet and at least one outlet, the duct configured to encompass rotating and stationary blades such that bladeless portion(s) of the duct is/are arranged essentially subsequently to bladed portions thereof,
the method further comprises:
integrating the at least one rotary apparatus into the production facility configured to carry out process or processes related to production of the material at temperatures essentially equal to or exceeding about 500 degrees Celsius (° C.),
conducting an amount of input energy into the at least one rotary apparatus integrated into the production facility, the input energy comprising electrical energy, and
operating the at least one rotary apparatus integrated into the production facility such, that thermal energy is imparted to a stream of fluidic medium flowing in the duct between the inlet and the outlet by virtue of a series of energy transformations occurring when said stream of fluidic medium successively passes through bladed and bladeless portions of the duct, whereby a stream of heated fluidic medium is generated, and
wherein the material produced includes one of (i) titanium oxide, (ii) mineral-wool, (iii) gypsum, (iv) wood pulp and paper, (v) cathodes/anodes for batteries, or (vi) flash-dried chemicals.

127. (canceled)
